(19) United States
(12) Patent Application Publication
(10) Pub. No.: US 2024/0391490 A1
(43) Pub. Date: Nov. 28, 2024

(54) SYSTEMS AND METHODS FOR AUTONOMOUS DRIVING BASED ON BOUNDED TRACKING

(71) Applicant: TuSimple, Inc., SAN DIEGO, CA (US)

(72) Inventors: Chunan HUANG, San Diego, CA (US); Patrik KOLARIC, San Diego, CA (US); Junbo JING, San Diego, CA (US); Yufei ZHAO, San Diego, CA (US)

(21) Appl. No.: 18/664,712

(22) Filed: May 15, 2024

Related U.S. Application Data
(60) Provisional application No. 63/502,571, filed on May 16, 2023.

(51) Int. Cl. B60W 60/00; B60W 50/00; B60W 50/06

(52) U.S. Cl. CPC B60W 60/001; B60W 50/0097; B60W 50/06; B60W 2050/0014; B60W 2720/24

(57) ABSTRACT

An example method for controlling a vehicle includes obtaining reference information relating to an operation parameter of the vehicle, the operation parameter describing mission waypoints of the vehicle at respective time points during which the vehicle is to traverse a path, the reference information including reference values of the operation parameter corresponding to the time points; obtaining context information of the vehicle that relates to a state of the vehicle during an operation of the vehicle at the respective time points or an environment enclosing the path; determining tolerable ranges of the operation parameter for the time points based on the reference information and the context information; obtaining penalty information relating to differences between respective tolerable ranges and corresponding values of a constraint at the time points; determining a control instruction based on the tolerable ranges and the penalty information; and operating the vehicle based on the control instruction.

### CROSS-REFERENCE TO RELATED APPLICATIONS

This application claims priority to and the benefit of U.S. Provisional Application No. 63/502,571, filed on May 16, 2023, the disclosure of which is incorporated herein by reference in its entirety.

### TECHNICAL FIELD

This document generally relates to autonomous driving, and in particular, generating control instructions for autonomous vehicles based on bounded tracking.

### BACKGROUND

Autonomous vehicle navigation is a technology for sensing the position and movement of a vehicle and, based on the sensing, autonomously control the vehicle to navigate towards a destination. Autonomous vehicle control and navigation can have important applications in the transportation of people, goods and services. Efficiently generating commands for the powertrain of a vehicle that enables its accurate control is paramount for the safety of the vehicle and its passengers, as well as people and property in the vicinity of the vehicle, and for the operating efficiency of driving missions.

### SUMMARY

Devices, systems, and methods for controlling a vehicle are described. An aspect of the present document relates to an example method for controlling a vehicle, including: obtaining reference information relating to an operation parameter of the vehicle, the operation parameter describing planned waypoints (or referred to as mission waypoints) of the vehicle at a plurality of time points during which the vehicle is to traverse a path, the reference information including a plurality of reference values of the operation parameter of the vehicle, each of the plurality of reference values corresponding to one of the plurality of time points; obtaining context information of the vehicle that relates to an operation of the vehicle at the plurality of time points or an environment enclosing the path; determining a tolerable range of the operation parameter for each of the plurality of time points based on the reference information and the context information; obtaining penalty information including a plurality of penalty weights each of which corresponds to a modulation bandwidth indicating a difference between a tolerable range and a constraint at one of the plurality of time points; determining a control instruction based on the tolerable ranges and the penalty information; and operating the vehicle based on the control instruction such that a value of the operation parameter of the vehicle at each of at least one of the plurality of time points falls within a tolerable range at the time point.

An aspect of the present document relates to a system, including at least one processor and memory including computer program code which, when executed by the at least one processor, cause the system to effectuate any one of the methods for controlling a vehicle as described herein.

An aspect of the present disclosure relates to a vehicle configured to be controlled according to any one of the methods for controlling a vehicle as described herein. The vehicle may be an autonomous vehicle.

An aspect of the present disclosure relates to at least one non-transitory computer readable medium, which, when executed by at least one processor, cause a system or an autonomous vehicle to operation according to any one of the methods described herein.

The above and other aspects and features of the disclosed technology are described in greater detail in the drawings, the description, and the claims.

### BRIEF DESCRIPTION OF THE DRAWINGS

FIG. 1 shows a block diagram of an example autonomous driving system 100 according to some embodiments of the present document.

FIGS. 2A-2C show examples of generating a scheduled control sequence based on an input which includes reference future states according to single tracking and bounded tracking according to some embodiments of the present document.

FIG. 2D illustrates the generation of constraints for the constraint-defined controller according to some embodiments of the present document.

FIG. 3A shows a process for controlling a vehicle according to some embodiments of the present document.

FIG. 3B shows a process for controlling a vehicle according to some embodiments of the present document.

FIG. 4 shows a flowchart of a process for determining a flowchart of a process for determining an optimized trajectory according to some embodiments of the present document.

FIG. 5 shows a flow for selecting a soft constraint according to some embodiments of the present document.

FIG. 6 illustrates an example for selecting a soft constraint according to the flow show in FIG. 5.

FIG. 7 shows an example flow for selecting control modes according to some embodiments of the present document.

FIG. 8 illustrates a process 800 for controlling a vehicle according to some embodiments of the present document.

FIG. 9 shows an example of a hardware platform that can implement some methods and techniques described in the present document.

FIG. 10 illustrates a block diagram of an example vehicle ecosystem according to some embodiments of the present document.

FIG. 11 shows a case study by simulating a deceleration scenario with a tight position constraint according to some embodiments of the present document.

FIG. 12 illustrates distance constraints violation amounts results from different controllers according to some embodiments of the present document.

FIG. 13 shows the comparison of histograms of jerk in control acceleration demand and in actual vehicle acceleration using the baseline and the bounded tracking-based control framework according to some embodiments of the present document.

FIG. 14 shows a cumulative distribution of an upper 10% of speed constraint violation amount based on the bounded tracking-based control framework according to some embodiments of the present document.

Like reference numerals denote like components or operations.

### DETAILED DESCRIPTION

The transportation industry has been undergoing considerable changes in the way technology is used to control the operation of vehicles. As exemplified in the automotive passenger vehicle, there has been a general advancement towards shifting more of the operational and navigational decision making away from the human driver and into on-board computing power. This is exemplified in the extreme by the numerous under-development autonomous vehicles. Current implementations are in intermediate stages, such as the partially-autonomous operation in some vehicles (e.g., autonomous acceleration and navigation, but with the requirement of a present and attentive driver), the safety-protecting operation of some vehicles (e.g., maintaining a safe following distance and automatic braking), the safety-protecting warnings of some vehicles (e.g., blind-spot indicators in side-view mirrors and proximity sensors), as well as case-of-use operations (e.g., autonomous parallel parking).

Different types of autonomous vehicles have been classified into different levels of automation under the Society of Automotive Engineers' (SAE) J3016 standard, which ranges from Level 0 in which the vehicle has no automation to Level 5 (L5) in which the vehicle has full autonomy. In an example, SAE Level 4 (L4) is characterized by the vehicle operating without human input or oversight but only under select conditions defined by factors such as road type or geographic area. In order to achieve SAE L4 autonomy, vehicle control commands must be efficiently computed while collaborating with both the high-level mission planner and the low-level powertrain characteristics and capabilities.

In existing autonomous and semi-autonomous systems, low-level powertrain control commands are typically generated to support adaptive cruise control (ACC), in which the controller is designed to either maintain a constant driving speed on a highway or to follow a lead vehicle while maintaining a safe following distance between the vehicles. In such systems, the controller passively reacts to a control target and vehicle state situation, and the determination of vehicle actuation is driven by control errors. The control target normally only refers to a static driving speed in a free cruise situation, or a dynamic driving speed determined only by the lead vehicle's instantaneous driving speed and the relative distance. In such cases, the control laws are normally designed to improve tracking accuracy, with other performance criteria being implicitly accounted for by control gain tuning. However, control gain tuning may inadvertently compromise tracking accuracy in some situations.

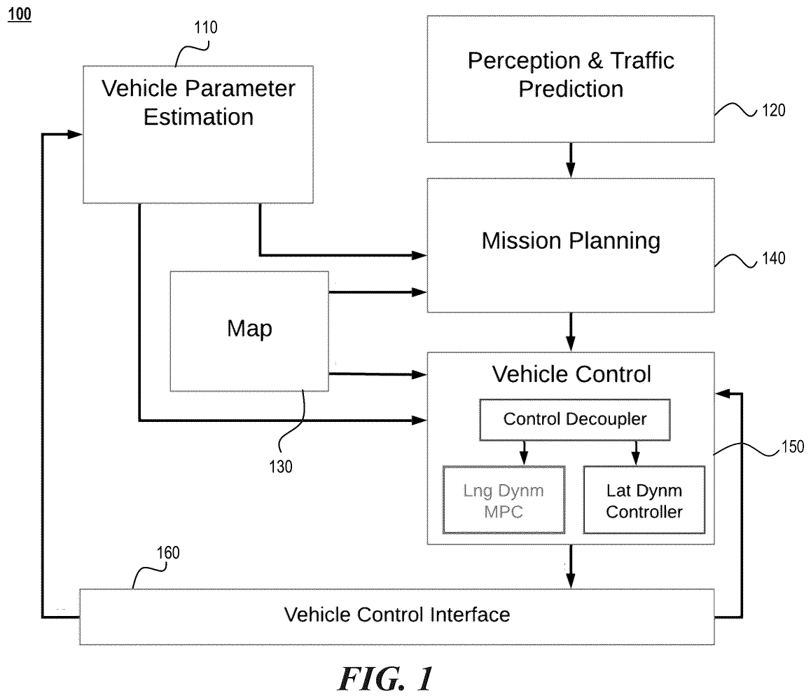

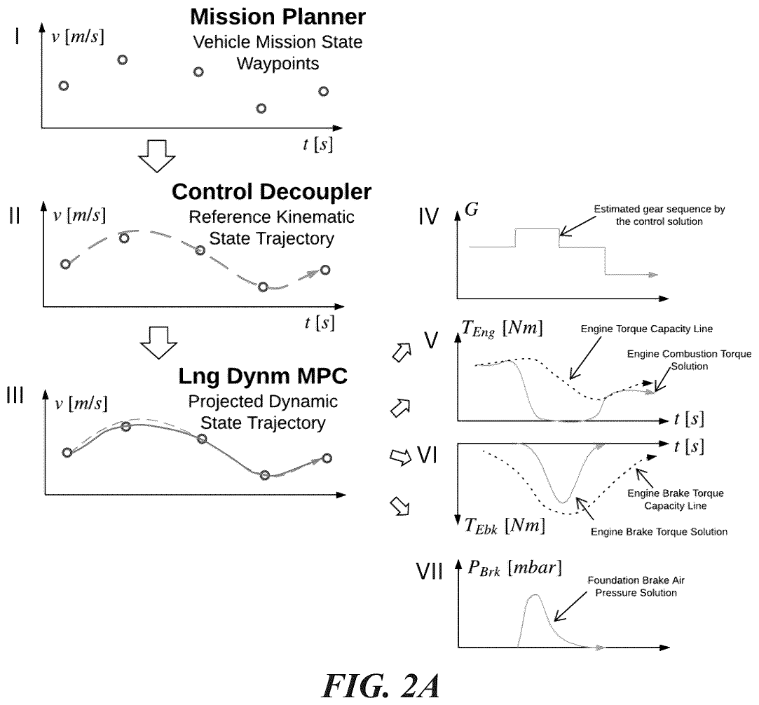

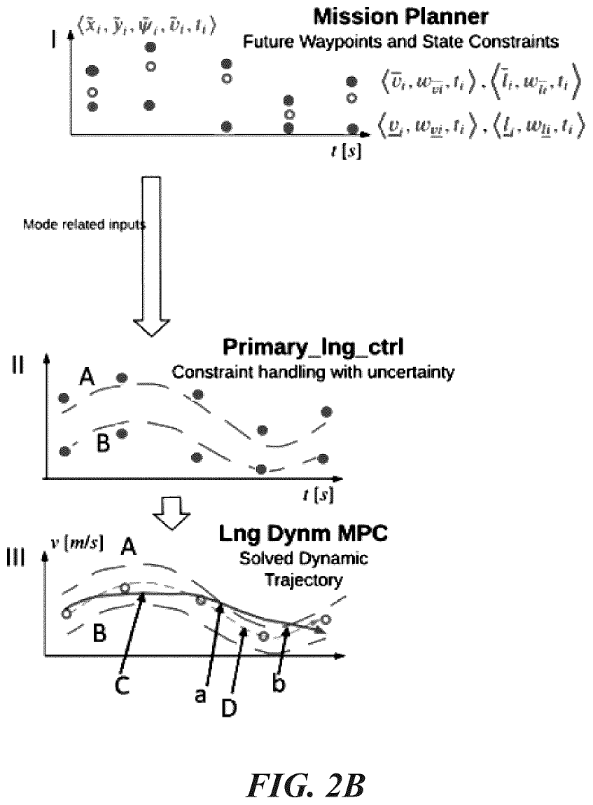

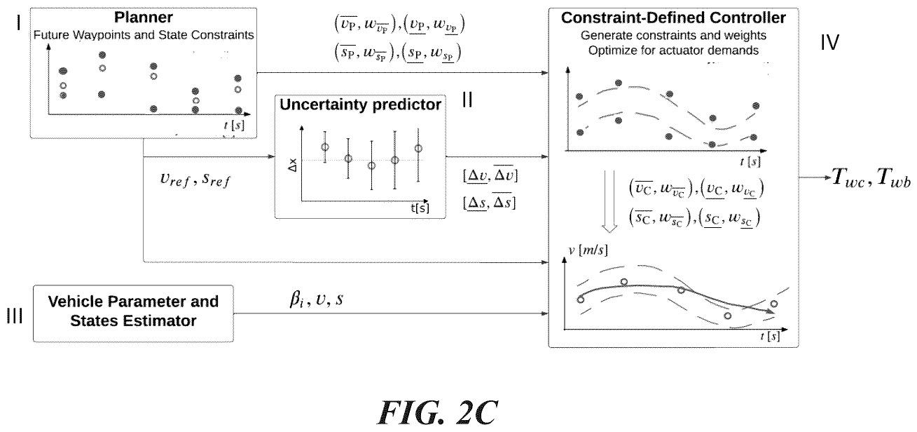

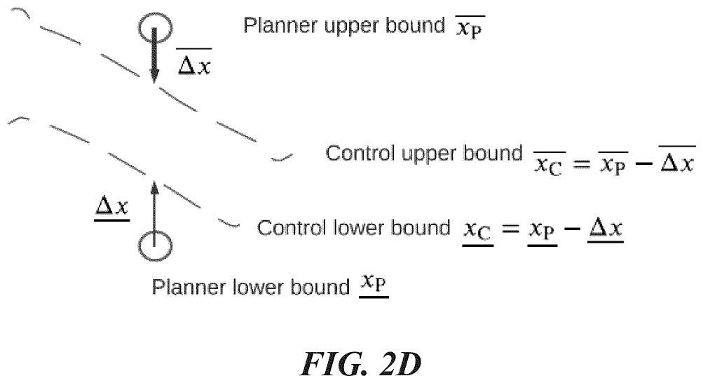

Embodiments of the disclosed technology are directed to systems and methods for autonomous driving based on a bounded tracking-based control framework. In some embodiments, the control framework or control system may contain: 1) an interface to an upstream planner module (e.g., mission planning module 140 as illustrated in FIG. 1) to receive motion boundaries (e.g., state constraints as part of the context information as described elsewhere in the present document) and safety risk levels (e.g., harshness levels as part of the context information as described elsewhere in the present document); 2) model and motion execution error uncertainty online prediction for the controller (e.g., the vehicle control module 150 as illustrated in FIG. 1, uncertainty predictor as illustrated in panel II of FIG. 2C); 3) information handler (e.g., vehicle control module 150 as illustrated in FIG. 1, or constraint-defined controller as illustrated in FIG. 2C) that takes the prior two information and generates appropriate state boundaries (e.g., tolerable ranges described elsewhere in the present document); 4) software (at, e.g., vehicle control module 150 as illustrated in FIG. 1, or constraint-defined controller as illustrated in panel IV of FIG. 2C) that formulates and solves the bounded predictive control problem and generates control commands (acceleration/speed/distance command as well as throttle brake operation) based on motion boundaries and optimization targets including motion safety, driving smoothness and fuel economy. Under the control framework, an autonomous driving system may generate actuator demands to follow speed reference waypoints generated from the planner, based on control objectives including tracking accuracy, motion smoothness, fuel economy, etc., while satisfying planner requested state constraints and considering the system uncertainties.

Embodiments of the bounded tracking-based control framework may allow adaptive behavior in the controller by not only taking the reference, but also the motion boundaries from the upstream planner-the motion boundaries provide a notion of “good enough,” and the controller may know whether it needs to further improve tracking accuracy. In other words, enabling state modulation can help achieve better fuel economy and smoothness performance at the cost of allowing an acceptable degradation in tracking accuracy.

For example, the controller may be calibrated to safely give more importance on driving smoothness and fuel economy when the sequence of commands satisfies the motion boundaries, while when it does not satisfy the motion boundaries, the controller may be calibrated to provide higher weights or emphasis on tracking accuracy, e.g., to make the control sequence converge back to the accepted region (e.g., within tolerable ranges as described elsewhere in the present document). That is, accurate tracking may no longer be limited to track a single reference, but may be changed into bounded tracking-tracking a reference with an accuracy level defined by or relating to motion boundaries. The motion boundaries may be formulated as or converted to soft constraints (e.g., tolerable ranges as described elsewhere in the present document) inside the model predictive controller (e.g., the MPC controller in the vehicle control module 150 as illustrated in FIG. 1), and may be eventually scaled and added into the optimization objective of the control problem, instead of being considered as a hard constraint. The controller may reduce or minimize the sum of the scaled original objective and scaled violations of soft constraints to achieve a balance between optimizing its objectives and satisfying motion constraints. This may make the controller more robust to errors. Merely by way of example, if there is an error in one step of the assigned motion boundaries (e.g., a deviation from an assigned motion boundary), instead of generating a sudden maneuver to satisfy a false requirement (e.g., to achieve an accurate or perfect tracking) or even return nothing due to infeasibility when, e.g., the boundaries are formulated as hard constraints, the controller may take actions to reduce the violation but with feasible actuator commands. Hence, the technical benefits of the bounded tracking-based control framework may include at least the following: 1) the accuracy of tracking an upstream reference (a reference value of an operation parameter determined by the upstream planner) can be lowered without compromising safety based on scenario-specific requirements, and/or 2) the controller can safely focus on optimizing user-defined control objectives other than the tracking accuracy, including driving smoothness and fuel economy, as long as its tracking accuracy is considered acceptable.

For illustration purposes and not intended to be limiting, embodiments of the control framework or control system are described with respect to an autonomous vehicle's longitudinal motion control. In some embodiments, two control modes may be implemented in the control system. In the first mode (i.e., tracking mode), tracking accuracy may function as the major control objective and the controller (e.g., a primary longitudinal controller in the example embodiments of longitudinal motion control) may decide an actuator demand to reduce or minimize a tracking error. In the second mode (i.e., modulation mode), tracking accuracy may still be considered, while additional objectives may also be taken into consideration, include motion smoothness or fuel economy (e.g., as user defined). For example, state modulation may be employed during light traffic and at relatively “simple” scenarios, e.g., highway during lane follow task or accept merge task, or when the planner demanded acceleration is not too large (e.g., below a threshold), while in other cases, high penalty on tracking error (e.g., a deviation from a motion constraint) may be applied to ensure accurate tracking performance.

As shown by the illustration in FIG. 2C, future waypoints and state (speed and longitudinal location) constraints (along the prediction horizon) may be generated by the mission planner (e.g., the mission planning module 140 as illustrated in FIG. 1), and then shrunk by an uncertainty manager (e.g., uncertainty predictor as illustrated in panel II of FIG. 2C) to determine modified state bounds (e.g., tolerable ranges as described elsewhere in the present document) inside primary longitudinal controller based on how much deviation is expected between model prediction to actual execution. This may ensure the final generated trajectory does satisfy the state boundaries (e.g., state constraints) requested by the mission planner, which may ensure safety of the vehicle. An optimization may occur within the primary longitudinal controller. The primary longitudinal controller may be a longitudinal dynamic MPC controller as illustrated in FIG. 1. The primary longitudinal controller may take the waypoint reference (e.g., reference information as described elsewhere in the present document) and the modified state bounds (tolerable ranges as described elsewhere in the present document) as input, and generate an optimal trajectory, as well as control demand as output.

Some embodiments relate to the determination of control instructions for proper vehicle level actuation including, e.g., engine torque demand, foundation brake pressure demand, and engine brake torque demand, in order for the vehicle to operate along a path based on reference information (regarding, e.g., position s and/or speed v) provided by the upper stream kinematic control. In addition to tracking the reference information, some embodiments of the present document allow context information to be considered in the determination of control instructions. The context information may refer to a set of data and/or factors describing the state of the vehicle in an operation of the vehicle relating to or guided by reference information (e.g., mission waypoints). The context information may include the vehicle's current physical, operational, and environmental conditions. Example context information may include the state of the vehicle at a prior time point or position, the mechanical capacity of a portion of the vehicle (e.g., engine, brake), a road condition (e.g., slippery road), the behavior of a vehicle or object in a vicinity of the vehicle), or the like, or a change or a combination thereof.

In some embodiments, a tolerable range of an operation parameter at a time point or waypoint may be determined based on the reference information and the context information. For example, the tolerable range may relate to uncertainty information regarding the reference information due to, e.g., the context information. The uncertainty information may be determined using an uncertainty model configured to predict a model error or uncertainty relating to, e.g., a discrepancy between a command and its execution. Merely by way of example, a discrepancy between a brake command and its execution may exist due to a delay in the execution of a brake command (in that it takes time for the brake pressure to change from its current value to a target value according to the brake command), a limit on the mechanical capacity of one or more components of the vehicle when executing a command, or the like, or a combination or a change (e.g., the wear of a brake over time) thereof. As another example, compared to the reference information of the vehicle determined by an upper stream kinematic control (e.g., a mission planning module (or referred to as a mission planner)) that provides a single value for an operation parameter at a time point or position while the vehicle travels along a path, the context information may be considered in determining a control instruction to provide an acceptable or tolerable range described using, e.g., an upper bound and a lower bound, of the operation parameter of the vehicle at the time point or position. Accordingly, the context information may allow room for selecting the operation parameter based on its own dynamic model and execution limitations in combination with one or more optimization considerations (e.g., fuel efficiency, ride comfort). In addition, instead of passively reacting to an instantaneous control error, the described embodiments may proactively determine the current control actuations based on a projection to future vehicle driving states, future deviations from the required target driving profile, and/or the aggregated performance criteria of the future driving motion details.

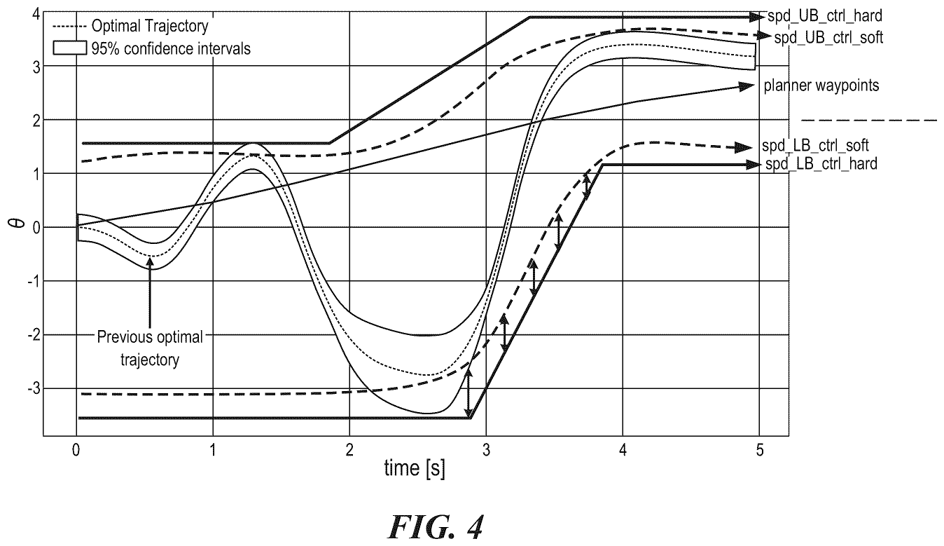

In some embodiments, the penalty of a deviation (e.g., reflected by a modulation bandwidth) of an operation parameter of the vehicle from a corresponding tolerable range may be dynamically modulated using penalty information that correlates with a safety margin of the operation parameter. A modulation bandwidth may indicate a difference between a tolerable range and a constraint (e.g., a state constraint as described elsewhere in the present document) at one of the plurality of time points. See, e.g., FIG. 4 and relevant description thereof. The penalty information may include penalty weights corresponding to the operation parameter at different time points or positions. Additionally or alternatively, the penalty of a deviation of an operation parameter of the vehicle from a corresponding tolerable range, or the penalty information, may relate to the nature of the constraint. In some embodiments, the nature of the constraint may be reflected in the harnessless levels specified by the planner. For example, a constraint may be a primary constraint or a secondary constraint. A primary constraint may correspond to a high harshness level and/or be directly safety related including, e.g., collision avoidance, speed limit. A secondary constraint may correspond to a low harshness level and/or be performance or user experience related including, e.g., ride comfort or acceleration jerkiness, fuel efficiency. Given a same modulation bandwidth, the penalty of a deviation of an operation parameter relating to a constraint corresponding to a higher harshness level may be higher, indicated by a higher penalty weight in the penalty information, than the penalty of a deviation of an operation parameter relating to a constraint corresponding to a lower harshness level.

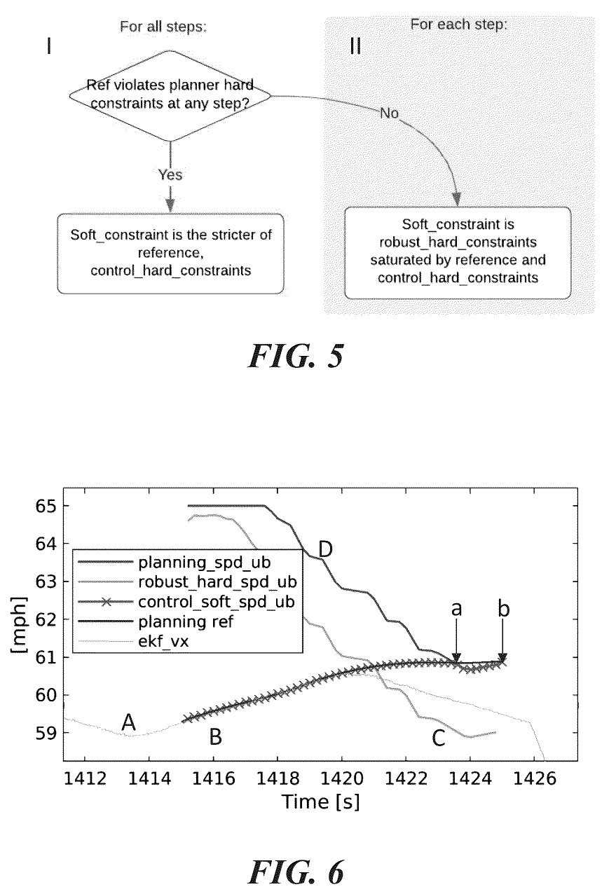

For example, for an operation parameter (e.g., position of the vehicle or a portion thereof), when the safety margin is small (e.g., indicated by a small modulation bandwidth at a time point, and/or the reference value being close to a primary constraint) so that a small deviation of its value from the corresponding reference value may cause a safety problem (e.g., when the vehicle is very close to another vehicle, a small deviation of the position of the vehicle from its reference value may cause a collision), the penalty weight of a deviation may be assigned with a high value so that it affects the control instruction significantly; on the other hand, when the safety margin of the operation parameter is large (e.g., indicated by a large modulation bandwidth at a time point, and/or the reference value being far away from a primary constraint), the penalty weight of such a deviation may be assigned with a low value so that it affects the control instruction insignificantly, thereby allowing room to adjust the value of the operation parameter to accommodate one or more other optimization considerations (e.g., fuel efficiency, ride comfort). While the vehicle travels along the path, at different time points or positions, the safety margin of a same operation parameter may change (due to, e.g., a change in a lane width, a change in the following distance between the vehicle and a preceding or following vehicle), and the penalty weight may be adaptively adjusted. Additionally or alternatively, when the safety margin of the operation parameter is too small or a reference value of the operation parameter is violated so that a safety concern becomes dominant, the control of the vehicle may be switched from a bounded tracking-based control mode in which the context information and/or the penalty information may be considered in the generation of control instructions to a tracking-based control mode in which the reference information of one or more operation parameters is tracked with higher accuracy. More description regarding a constraint may be found elsewhere in the present disclosure. See, e.g., FIGS. 5 and 6 and relevant description thereof.

Accordingly, instead of single reference tracking, embodiments of the present document allow adaptive bounded tracking (or referred to as state modulation) which, without compromising safety, may lead to improved performance of the vehicle in terms of, e.g., fuel consumption minimization and ride comfort.

In some embodiments, the described methods, devices, and systems are directed to SAE L4 autonomous driving dynamic control systems, which cover SAE L1-L3 driving assistance applications, semi-autonomous systems, and expand to the full coverage of vehicle dynamic control needs in real-world driving, including lane changes, merging into traffic, navigating highway on/off ramps, passing through intersections, maneuvering through congested traffic, parking and docking operations, etc. In contrast to conventional systems that focus on a single tracking based on a single or isolated control target, embodiments of the disclosed technology are part of the processing of a control technique that involves adaptive control targets defined in multiple dimensions.

In some embodiments, vehicle control actuations are generated for a target profile in multiple temporal dimensions and are also optimized to account for the co-existence of multiple performance criteria, e.g., tracking accuracy, state motion smoothness, actuation change smoothness, fuel economy, and brake preservation. This may be achieved by using model predictive control (MPC), which implements an iterative, finite-horizon optimization. According to some embodiments, MPC may explore state trajectories that emanate from the current state and select an optimized trajectory that extends to the finite-horizon. In some embodiments, one or more techniques including, e.g., move blocking, may be employed to enforce a constant control command over a certain period within the prediction horizon, and reduce the dimensionality of the underlying optimization problem to speed up computation. In some embodiments, MPC is used to implement the predictive generation of the vehicle control actuations, which may evolve over time based on real-world driving situations deviating from trajectories generated by the high-level (or upper stream) perception planning system.

FIG. 1 shows a block diagram of an example autonomous driving system 100 that implements embodiments of the disclosed technology, which leverage the capabilities of MPC. As shown therein, an example autonomous driving system includes a vehicle parameter estimation module 110, a perception and traffic prediction module 120, a map module 130, a mission planning module 140, a vehicle control module 150, and a vehicle control interface 160. In some embodiments, the perception and traffic prediction module 120 can be configured to provide a context for driving situations, label the states of various nearby vehicles, identify instantaneous driving intentions, and predict future states of key neighboring vehicles. In some embodiments, the mission planning module 140 can be configured to use an abstracted ego vehicle motion model into the aforementioned driving situation context and generate an abstracted driving mission plan for a few seconds of time into the future, or referred to as a preview horizon or prediction horizon.

In some embodiments, the vehicle control module 150 includes a control decoupler that is operably connected to the lateral dynamic controller and the longitudinal dynamic MPC. The vehicle control module 150 may generate control commands that are transmitted to the powertrain of the vehicle via the vehicle control interface 160. In other embodiments, the vehicle control interface 160 may also be configured to feedback time-series data from the powertrain and/or other engine domain and wheel domain components to the vehicle parameter estimation module 110. The following description is provided with reference to a longitudinal motion control for illustration purposes, without the intention to be limiting. It is understood that the disclosed technology can be applied in lateral motion control.

Generating the vehicle control actuations is constrained by the mechanical capacity of various components of the vehicle including, e.g., the maximum actuation capability of the vehicle. In contrast to control systems designed for SAE L3 and below (e.g., driving assistance and semi-autonomous driving) that requires the driver to take responsibility when a motion abnormality occurs, the disclosed embodiments are configured to provide full vehicle motion safety liability. In some embodiments, this may be achieved by investigating the state reachability and motion feasibility of the control scenario and modulating the vehicle state proactively in a time-varying manner subject to vehicle state constraints required by the autonomous driving planner for safety (e.g., minimum or maximum vehicular speed, position, or acceleration). Because the control actuation is proactively scheduled for future driving missions with consequence projection, the described embodiments can dynamically allocate vehicle actuation resources for future challenging motion events (e.g., prematurely configuring a high horsepower output phase), thereby achieving better state constraint compliance than conventional passive error-driven controllers.

Merely by way of example, the amount of relaxation may be represented by the amount of corresponding slack variables. When an upper level state constraint exceeds the nominal actuation capability of the vehicle, the infeasible state constraint may be relaxed by a minimum amount while increasing or maximizing the vehicle actuation using slack variable techniques, which may reduce the potential risk at the output of the corresponding system module. If multiple state constraints are to be violated (exceeding the corresponding actuation capacities of the vehicle, or portions thereof), the vehicle operation may be regulated such that the constraint with the highest penalty be violated the least. This may be done by optimizing the total risk, defined by a weighted sum of the slack variables, with the weights corresponding to the penalty levels. This capability of fully utilizing the vehicle's output to be compliant with a required motion constraint to an increased or maximum extent is one of the advantages of the described embodiments compared to conventional autonomous driving capabilities.

FIGS. 2A-2C show examples of generating a scheduled control sequence based on an input which includes reference future states according to a tracking-based control mode and a bounded tracking-based control mode, respectively, according to some embodiments of the present document. FIGS. 2A-2C illustrates a series of vehicle mission waypoints (or waypoints for brevity, corresponding to various time points) in the form of a discrete velocity time-series. It is for illustration purposes only and not intended to be limiting. The waypoints may also be in the form of a discrete position time-series, or the like, or a combination thereof.

Examples of powertrain control commands include control commands for engine combustion torque, and engine brake torque. The foundation air brake pressure is an example of the foundation brake control command. The disclosed embodiments can be implemented in a variety of autonomous vehicles, including class-8 trucks (which may use foundation air brakes), as well as lighter-duty trucks (which use hydraulic brakes).

As illustrated in FIG. 2A, the input from the mission planner (e.g., mission planning module 140 in FIG. 1), includes a series of vehicle mission waypoints in the form of a discrete velocity time-series represented by the open circles in panels I, II, and III of FIG. 2A. The mission planner is configured to provide this initial coarse mission plan or objective, which is subsequently refined to generate a scheduled optimal control sequence.

The control decoupler (e.g., vehicle control module 150 in FIG. 1) then generates a reference kinematic state trajectory represented by the dashed line in panel II of FIG. 2A that passes through each of the vehicle mission waypoints. This represents a next stage of refinement in which the discrete waypoints are decoupled into lateral dimension and longitudinal dimension. The lateral dimension of the reference kinematic state trajectory is processed by a lateral dynamic controller. The longitudinal dimension of the reference kinematic state trajectory is processed by a longitudinal dynamic MPC to generate a projected dynamic state trajectory that is a more realistic representation of the vehicle's actual behavior than the kinematic state trajectory that can be achieved given the vehicle's physical (or mechanical) and control limitations. This represents a next stage of refinement in which the reference trajectory evolves into a realistic trajectory. The final stage of refinement generates multiple low-level control signals based on the projected dynamic state trajectory. As shown in FIG. 2A, low-level control signals can include an estimated gear sequence by the control solution as illustrated in panel IV, an engine combustion torque solution as illustrated in panel V, an engine brake torque solution as illustrated in panel VI, and a foundation brake air pressure solution as illustrated in panel VII.

The example implementation shown in FIG. 2A includes the iterative addition of complexity at each stage, which enables the final low-level control signals to be generated in a computationally efficient manner. Some conventional approaches generate low-level control signals directly from a mission plan, albeit at the expense of significantly more computational complexity. FIG. 2A illustrates a tracking-based control mode in which reference values of the velocity are tracked, without taking into consideration the uncertainty due to context information including, e.g., a discrepancy relating to a control command with respect to an actual execution thereof.

FIG. 2B illustrates a bounded tracking-based control mode according to some embodiments of the present document. Similar to FIG. 2A, the input from the mission planner (e.g., mission planning module 140 in FIG. 1) includes a series of vehicle mission waypoints in the form of a discrete velocity time-series represented by the open circles in panels I, II, and III of FIG. 2B. The mission planner is configured to provide this initial coarse mission plan or objective, which is subsequently refined to generate a scheduled optimal control sequence. The dashed line, curve D traversing all the open circles shown within panel I and panel III of FIG. 2B, illustrates a reference kinematic state trajectory determined based on the tracking-based control mode as illustrated in FIG. 2A.

The solid dots in panel I of FIG. 2B constitute pairs each of which describes a range defined by an upper bound and a lower bound (represented by two solid dots corresponding to a same time point) of the velocity corresponding to a reference value of the velocity at a time point. The differences between the solid dots and their respective corresponding reference values may reflect one or more tolerance levels of the corresponding state constraints at the time point. State constraints may include, for example, vehicle stability, ride comfort, speed limit, and collision avoidance. A state constraint may be a primary constraint or a secondary constraint. A primary constraint may be safety related including, e.g., collision avoidance, speed limit. A secondary constraint may be performance or user experience related including, e.g., ride comfort or acceleration jerkiness, fuel efficiency. Curve A and curve B in panel II of FIG. 2B are obtained by moving the solid dots inward (closer to corresponding reference values or toward safer values) based on uncertainty values predicted using, e.g., an uncertainty model (by inputting the context information and the reference information into the uncertainty model) and subsequently connecting the moved solid dots. Curve A and curve B show the upper bounds and the lower bounds of the velocity at various waypoints, respectively. The region between curves A and B may be considered a safe region with respect to the velocity in which safety of the vehicle is deemed ensured. Panel III of FIG. 2B illustrates curve C corresponding to an optimized trajectory determined based on the safe region between curves A and B in combination with one or more additional optimization considerations (e.g., fuel efficiency, ride comfort or smoothness). Curve D does not coincide with curve C. A first portion of curve C to the left of point a is within the safe region between curves A and B, indicating that values of the velocity within this portion of curve C satisfy constraints described based on the context information. A second portion of curve C between points a and b is outside the safe region between curves A and B, indicating that values of the velocity within this portion of curve C violate the constraints described based on the context information. A third portion of curve C to the right of point b returns to the safe region between curves A and B, indicating that values of the velocity within this portion of curve C satisfy constraints described based on the context information.

FIG. 2C illustrates a bounded tracking-based control mode according to some embodiments of the present document. Similar to FIGS. 2A and 2B, the input from the planner (e.g., mission planning module 140 in FIG. 1) includes a series of vehicle mission waypoints illustrated by the open circles in panels I and IV of FIG. 2C and the context information illustrated by the solid dots in panels I and IV of FIG. 2C. The vehicle mission waypoints may be in the form of a discrete reference speed (or referred to as reference velocity) and distance time sequences v_{ref}(k|t) and s_{ref}(k|t), k∈[1, 2, . . . , N_{P}], where k represents the kth step within the preview horizon N_{P}, and t represents a current timeframe. The solid dots illustrating the context information in panels I and IV of FIG. 2C illustrate pairs each of which describes a range defined by an upper bound and a lower bound (represented by two solid dots corresponding to a same time point) of the velocity (or referred to as speed) or distance corresponding to a reference value of the velocity or distance at a time point. The context information may include one or more state constraints and corresponding harshness levels the planner specifies. The state constraints of the context information specified by the planner may be referred to as planner constraints or control hard constraints described elsewhere in the present document. See, e.g., FIGS. 5 and 6 and relevant description thereof. For example, the context information may include speed upper and lower constraints and their corresponding harshness levels (v̅(k|t), w_{v̅}(k|t)) and (v(k|t), wᵥ(k|t), and/or distance (or position) upper and lower constraints and their corresponding harshness levels (s̅(k|t), w_{s̅}(k|t) and (s(k|t), w_{v̅}(k|t), v_{ref}, s_{ref}, (v̅_̅{̅P̅}̅, wᵥ̅_̅{̅_̅{̅P̅}̅}̅), (v_{P}, wᵥ_{_{P}}), (s_{P}, wₛ_{_{P}}), and (s_{P}, wₛ_{_{P}}), illustrated in FIG. 2C, illustrate the whole sequences with the preview horizon. For example, v_{ref} in FIG. 2C denotes [v_{ref}, (1|t), v_{ref}(2|t), . . . , v_{ref}(Nₚ|t)]. In some embodiments, there may be none, one, or more of such constraints spanning the prediction horizon for each state (e.g., speed or position) and type (e.g., upper or lower) pair (e.g., a speed upper constraint, a speed lower constraint, speed upper and lower constraints, a distance upper constraint, a distance lower constraint, distance upper and lower constraints, etc.). The differences between the solid dots and their respective corresponding reference values may reflect one or more state tolerance. A harshness level may be assigned based on one or more factors including, e.g., safety criticality of the corresponding boundary or boundaries. For example, a collision related constraint may be assigned with a higher harshness level than a comfort related constraint. A constraint with a lower harshness level may be violated when applicable than a constraint with a higher harshness level.

The reference information and context information may be input to an uncertainty predictor (e.g., an uncertainty model as described elsewhere in the present document) as illustrated in panel II of FIG. 2C. The uncertainty predictor may utilize the reference information (e.g., the reference state sequences as illustrated by the open circles in panels I and IV of FIG. 2C) and the context information (or referred to as the current vehicle state information as illustrated by the solid dots in panels I and IV of FIG. 2C) for the preview horizon to estimate the distribution of deviations in states, Δx (k|t)=[Δv(k|t), Δs(k|t)]^{T} between modeled state sequences and the executed state sequences.

The uncertainty predictor may include a model trained offline. To account for variations of control delivery quality across different operating scenarios, multiple uncertainty models may be trained offline using diverse and/or balanced datasets. Such datasets may include those collected from road trips (e.g., past test trips), synthetic datasets generated by simulations, or the like, or a combination thereof. As used herein, a dataset being diverse may indicate that the dataset include data representing various operation scenarios or conditions (e.g., free cruising, following traffic, executing cut-in, merging, lane changing, accelerating on ramps, decelerating on off-ramps, etc.). As used herein, a dataset being balanced may indicate that the amounts of data representing different operation scenarios are comparable. For example, the amount of data representing the operation scenarios of following traffic may be comparable to the amount of data representing the operation scenarios of executing cut-ins. As used herein, comparable amounts of data may indicate that the data volumes representing different operational scenarios are of the same order of magnitude. Different uncertainty models may target different operating scenarios, such as on-ramp acceleration, cruising at constant speed and harsh braking events, for the control task to operate in.

During onboard uses, the operation condition may be evaluated to guide a selection of a suitable uncertainty model. Given a confidence level p, a state reference sequence X_{ref}, and a current states xₜ, the uncertainty predictor may provide the range of deviations [Δx(k|t), Δ̅x̅(k|t)], where P(Δx≤Δx≤Δ̅x̅|xₜ, X_{ref}). This evaluation may be performed for both speed and position. Merely by way of example, both speed and position deviations may be modeled independently as multi-variate Gaussian distributions. Additional description of a multi-variate Gaussian distribution model may be found at, e.g., Gaussian Process Model of Uncertainty in Safety-Critical Autonomous Driving, 2023 IEEE 26th International Conference on Intelligent Transportation Systems (ITSC), P. Kolaric, et al., U.S. Provisional Application No. 63/502,578 filed May 16, 2023, and U.S. patent application Ser. No. ______ (Attorney Docket No.: 128000.8260.US01), filed on even date, the contents of each of which are incorporated by reference.

The output of the uncertainty predictor may be input to a constraint-defined controller as shown in panel IV of FIG. 2C. The dashed line in the upper figure in panel IV may be determined by moving the solid dots inward (closer to corresponding reference values or to a safer side) by the uncertainty degree at various time points and then connecting the moved solid dots. The dashed lines define a safe region (similar to the safe region between curves A and B in panel III of FIG. 2B). The safe region may be described as tolerable ranges of an operation parameter at various time points. The penalty weights may be determined based on a modulation bandwidth at each of various time points, as described elsewhere in the present document. Based on the safe region in combination with one or more vehicle parameters (exemplified by [symbol] ᵢ and state estimator (represented using velocity v and position s), constraints and penalty weights (or weights for brevity), the constraint-defined controller may improve or optimize actuator demands (e.g., control commands) indicated by or corresponding to the solid line in the bottom figure in panel IV of FIG. 2C. The output of the constraint-defined controller may include the wheel domain torque (e.g., generated by engine combustion and engine coasting friction) Twc and the wheel brake torque Twb.

Merely by way of example, a wheel domain longitudinal control problem (as an example control problem) may be formulated as a receding horizon optimal control problem (OCP) expressed below:

| min [symbol] | |
|---|---|
| s.t. | |
| x(t + 1) = x(t) + f(x, u)dt | |
| x(t₀) = x₀ | |
| C(x, u) ≤ 0 | |
| | , (1) |

in which x, u, f, J, and C denote the system states (or referred to as vehicle states), the control demands (e.g., torque and brake demands), a function describing the system dynamics (e.g., a change of the state of the vehicle over time), an objective function (or referred to as a cost function), and state or actuator constraints, respectively. Merely by way of example, with two states including s for position and v for vehicle speed, the control-oriented longitudinal dynamic model for the problem may be expressed as:

$$\{ \begin{matrix}\dot{s} = v \\ \dot{v} = {β}_{1} {T}_{wc} + {β}_{2} {T}_{wb} + {β}_{3} {v}^{2} + {β}_{24} θ + {β}_{5}\end{matrix} , \qquad ( 2 )$$

where T_{wc} corresponds to the wheel domain torque generated by engine combustion and engine coasting friction; T_{wb} corresponds to the wheel brake torque in addition to the negative torque by transmission friction from in-gear coast down; θ is the road grade which in practice may be provided through map information; and βₖ (k=1, 2, . . . 5) are the control oriented parameters, which may be estimated in real-time by vehicle parameter estimation algorithms.

In some embodiments, the control problem under a tracking-based control mode may be described based on a cost function relating only to the reference information provided by the mission planner:

$$min J = min {\sum }_{p = 1}^{M} {J}_{p} , where {J}_{p} = {\sum }_{i = k + 1}^{k + N} {j}_{p , i} \qquad ( 3 )$$

$$subject to \underline{{T}_{w , i}} \leq {T}_{w , i} \leq \overline{{T}_{w , i}} , \underline{v} \leq {v}_{i} \leq \overline{v} ,$$

in which J denotes an objective function (or referred to as a cost function), Tw,i denotes a torque generated by a vehicle at waypoint i (or time point i), T_{w,i} and T̅_̅{̅w̅,̅i̅}̅ denote the lower bound and the upper bound of the torque capacity (e.g., T_{wc} and T_{wc} denoting the lower and upper bounds of the wheel domain torque, respectively; T_{wb} and T̅_̅{̅w̅b̅}̅ denoting the lower and upper bounds of the wheel brake torque, respectively) at waypoint i (or time point i), respectively, v denotes the velocity of the vehicle (or referred to as vehicle speed), and v and v̅ denote the lower bound and the upper bound of the velocity at waypoint i (or time point i), respectively. The objective function items may be defined by a user. The torque capacity at a specific waypoint i may depend on the mechanical capacity of the vehicle (e.g., the engine of the vehicle) and/or the torque at a preceding waypoint because the change of the torque depends on the mechanical capacity of the vehicle as well.

For example, a controller formulation that focuses on local trajectory tracking, the objective function (or referred to as the baseline formulation) may relate to (e.g., a lump sum of) two objective function items, including 1) tracking the upstream state references, i.e., speed and position, represented by Jₜᵣ, and 2) reduction or minimization of efficiency and comfort related performance metrics, which may include, e.g., acceleration and jerk magnitudes, as well as fuel consumption, represented by J_{effi} as exemplified as:

$$min J = {min}_{{T}_{wc} , {T}_{w b}} {J}_{tr} + {J}_{effi} . \qquad ( 4 )$$

As for the actuator constraints in the baseline formulation (4), feasible ranges for the wheel propulsion and brake torque may be determined by the engine operation condition. Merely by way of example, the engine operation condition may be determined using a planner speed reference sequence and current engine and/or transmission status as described elsewhere in the present document. For simplicity, the actuator constraints may be expressed as:

$$\underline{{T}_{wc}} \leq {T}_{wc} ( k \vert t ) \leq {T}_{wc} , \qquad ( 5 A )$$

$$and$$

$$\underline{{T}_{wb}} \leq {T}_{wb} ( k \vert t ) \leq {T}_{wb} . \qquad ( 5 B )$$

In some embodiments, the control problem under a bounded tracking-based control mode may be built upon the baseline controller (e.g., a tracking-based controller) and have a modified objective function. For example, the bounded tracking-based control mode may include one or more additional terms in the objective function and/or the constraints to satisfy the boundaries (e.g., T_{w,i} and T̅_̅{̅w̅,̅i̅}̅) with defined harshness levels. For both speed and position, assuming an optimal state sequences X*are not far away from the reference state sequences X_{ref} (e.g., the deviation of the optimal state sequences X*from the reference state sequences X_{ref} being below a threshold) and thus share a same state uncertainty model, then for the executed state X*+Δ(X*) to satisfy the planner requested boundaries, i.e., x≤x*+Δ(x*)≤x̅ with probability p for each step k (k omitted for notation simplicity); it is essentially equivalent as requesting x*≥x−Δx, and x*≤x̅−Δ̅x̅.

To avoid infeasibility issues (e.g., the engine and/or brake having a limited mechanical capacity) and/or to include the information of harshness levels associated with boundaries, the control problem may be solved by introducing soft constraints implemented through one or more slack variables. In some embodiments, a slack variable is non-zero only when the corresponding constraint is violated. For a planner constraint (e.g., control hard constraint as described with respect to FIGS. 5 and 6) with lower and upper boundary values x_{P} and x̅_̅{̅P̅}̅, the value of the state boundary used in control may be set to be x_{C}=x_{P}−Δx and x̅_̅{̅C̅}̅=x̅_̅{̅P̅}̅−Δ̅x̅, where the subscript C stands for “controller,” and the subscript P stands for “planner.” See also FIG. 2D illustrating the generation of the constraints for the constraint-defined controller. Additional state constraints for speed and position may be expressed as:

$$Speed upper bounds : \{ \begin{matrix}v ( k \vert t ) \leq \overline{{v}_{C}} ( k \vert t ) + {ϵ}_{\overline{v}} ( k \vert t ) \\ {ϵ}_{\overline{v}} ( k \vert t ) \geq 0\end{matrix} , \qquad ( 6 )$$

$$Speed lower bounds : \{ \begin{matrix}v ( k \vert t ) \leq \underline{{v}_{C}} ( k \vert t ) + {ϵ}_{\underline{v}} ( k \vert t ) \\ {ϵ}_{\underline{v}} ( k \vert t ) \geq 0\end{matrix} , \qquad ( 7 )$$

$$Position upper bounds : \{ \begin{matrix}s ( k \vert t ) \leq \overline{{s}_{C}} ( k \vert t ) + {ϵ}_{\overline{s}} ( k \vert t ) \\ {ϵ}_{\overline{s}} ( k \vert t ) \geq 0\end{matrix} , \qquad ( 8 )$$

$$and$$

$$Position lower bounds : \{ \begin{matrix}s ( k \vert t ) \leq \underline{{s}_{C}} ( k \vert t ) + {ϵ}_{\underline{s}} ( k \vert t ) \\ {ϵ}_{\underline{s}} ( k \vert t ) \geq 0\end{matrix} . \qquad ( 9 )$$

A violation of one of the boundaries exemplified in Equations (6)-(9) may be penalized in the objective function after scaled by their corresponding penalty weights. A penalty weight may be determined based on the harness level specified by the planner (expressed as, e.g., wᵥ̅_̅{̅ₚ̅}̅) and the probability density value of the deviation amount (expressed as, e.g., f_{pdf} (Δ̅x̅)). Using the speed upper bound as an example, the penalty weight may be determined according to the expression:

$${w}_{\overline{{v}_{C}}} = {w}_{1} \cdot {w}_{2} , with {w}_{1} , {w}_{2} \geq 0 , \qquad ( 10 )$$

where w₁˜wᵥ̅_̅{̅ₚ̅}̅, w₂˜f_{pdf}(Δ̅x̅), and P(Δx≤Δx≤Δ̅x̅|x)=p. For a Gaussian distribution, the deviations may be a normalization about the standard deviation. By violating the constraint x*≤x̅−Δ̅x̅ by δx, the drop in the confidence level may be determined by

$$P ( {x}^{*} + \overline{Δ x} \leq \overline{x} ) - P ( {x}^{*} + \overline{Δ x} \leq \overline{x} - δ x ) \approx {f}_{pdf} ( \overline{Δ x} ) \cdot δ x . \qquad ( 11 )$$

Accordingly, the corresponding additional penalty term may be expressed as:

$${J}_{ϵ} = {ϵ}_{\overline{v}}^{T} Diag ( {w}_{\overline{v}}^{2} ) {ϵ}_{\overline{v}} + {ϵ}_{\underline{v}}^{T} Diag ( {w}_{\underline{v}}^{2} ) {ϵ}_{\underline{v}} + {ϵ}_{\overline{s}}^{T} Diag ( {w}_{\overline{s}}^{2} ) {ϵ}_{\overline{s}} + {ϵ}_{\underline{s}}^{T} Diag ( {w}_{\underline{s}}^{2} ) {ϵ}_{\underline{s}} , \qquad ( 12 )$$

where Diag (·²) generates a diagonal matrix with squared values of · being the diagonal elements; and w·s are the penalty weight sequences corresponding to violations ϵ within the preview horizon. It follows that the objective function built based on the baseline formula as illustrated by Equation (4) becomes:

$$min J = {min}_{{T}_{wc} , {T}_{wb} , {ϵ}_{\overline{v}} , {ϵ}_{\underline{v}} , {ϵ}_{\overline{s}} , {ϵ}_{\underline{s}}} {J}_{tr} + {J}_{effi} + {J}_{ϵ} . \qquad ( 13 )$$

Alternatively, the control problem under a bounded tracking-based control mode may be described based on a cost function represented by:

$$min J = min {\sum }_{p = 1}^{M} {J}_{p} + {J}_{{ϵ}_{v}} + {J}_{{ϵ}_{s}} , \qquad ( 14 )$$

$${J}_{{ϵ}_{v}} = {\sum }_{i = k + 1}^{k + N} {w}_{v , i} {ϵ}_{v}^{2} , {J}_{{ϵ}_{s}} = {\sum }_{i = k + 1}^{k + N} {w}_{s , i} {ϵ}_{s}^{2}$$

$$subject to \underline{{T}_{w , i}} \leq {T}_{w , i} \leq \overline{{T}_{w , i}}$$

$$\{ \begin{matrix}{x}_{i} \leq {x}_{RefSftMax} + {ϵ}_{x , i} \\ {x}_{i} \geq {x}_{RefSftMin} - {ϵ}_{x , i} \\ {ϵ}_{x , i} \geq 0\end{matrix} ,$$

in which J_{ϵ}_{ᵥ} and J_{ϵ}_{_{S}} denote cost function items relating to satisfaction of the velocity and the position boundaries of a vehicle, respectively, ϵᵥ and ϵ_{S} denote violations of safety margins relating to the velocity and the position of the vehicle, respectively, w_{v,i} and w_{s,i} denote penalty weights applicable to the velocity and the position safety margin violations at waypoint (or time point) i, respectively, xᵢ denotes a state of the vehicle (or referred to as a vehicle state) at waypoint (or time point) i in the form of the velocity or position, x_{Ref} denotes the reference value of the vehicle state at waypoint (or time point) i, Sft_{Max} and Sft_{Max} denote the soft state boundaries (or referred to as control soft constraints or tolerable ranges as described elsewhere in the present document) (maximum (or upper bound) and minimum (or lower bound)) generated from planner constraints (or referred to as planner hard constraints, or state constraints) and an uncertainty model, respectively, and ϵ_{x,i} denotes the safety margin of the vehicle state at waypoint (or time point) i.

When the safety margin of an operation parameter describing the vehicle state at a waypoint (or time point) is small (e.g., reflected by a small modulation bandwidth at the waypoint (or time point), and/or the reference value being close to a primary constraint), a high penalty weight may be assigned to enhance/highlight the impact of a deviation of the value of the operation parameter at a specific waypoint (or time point) from its corresponding reference value such that the control instruction may be determined to adjust the operation parameter to converge toward its reference value at the waypoint or a reference value at a subsequent waypoint (or time point) considering that the adjustment may take some time. In some embodiments, a primary constraint may be one that closely relates to safety such that a violation thereof may cause an accident or a high risk of such an accident. In some embodiments, a primary constraint may relate to a limit on the mechanical capacity of the vehicle such that a violation thereof indicates that a corresponding control command cannot be performed by the vehicle. Accordingly, a violation of a primary constraint needs to be avoided or corrected as quickly as possible. When the safety margin of the operation parameter describing the vehicle state at a waypoint (or time point) is large (e.g., reflected by a large modulation bandwidth at the waypoint (or time point), and/or the reference value being far away from a primary constraint), a low penalty weight may be assigned to reduce/diminish the impact of a deviation of the value of the operation parameter at a specific waypoint (or time point) from its corresponding reference value such that the control instruction may be determined by taking into consideration one or more other optimization considerations (e.g., fuel efficiency, ride comfort or smoothness). Accordingly, the bounded tracking-based control mode may take into consideration of optimization consideration more than the tracking of the reference information from the upper stream dynamic planning or control, allowing improvement in the vehicle performance in terms of, e.g., fuel economy, acceleration jerkiness (or ride comfort or smoothness), without compromising safety.

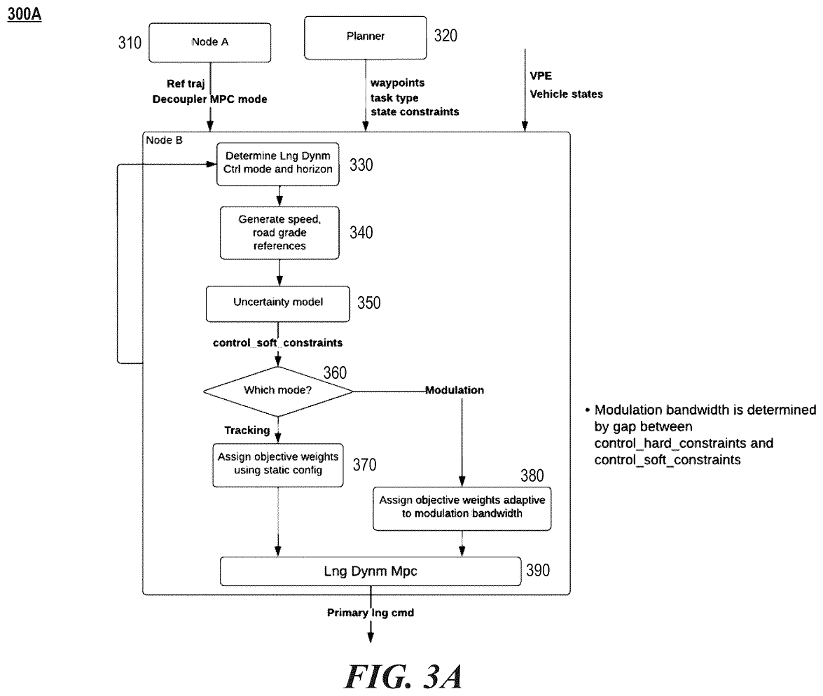

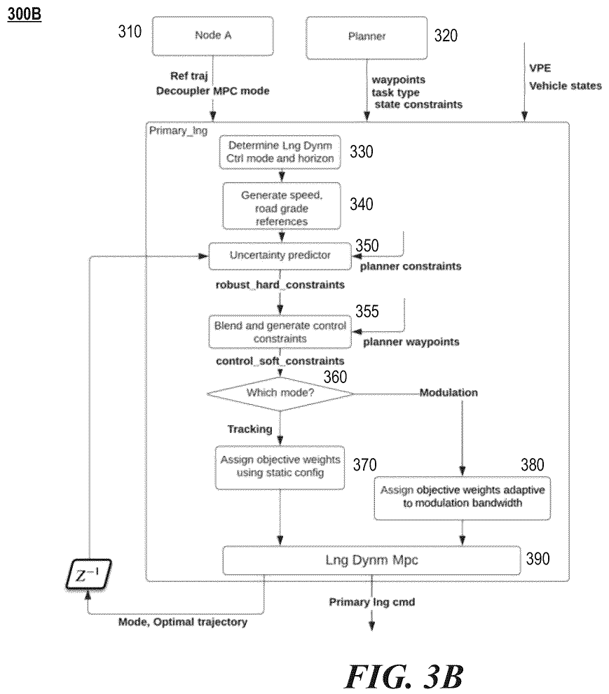

FIG. 3A shows a process 300A for controlling a vehicle according to some embodiments of the present document. At 310, the process 300A may provide to node B a reference trajectory determined by, e.g., a control decoupler under the MPC mode, based on reference information of a vehicle. The reference trajectory may be used as an input to node B according to a bounded tracking-based control mode. At 320, the process 300A may provide to node B the input from the mission planner (e.g., mission planning module 140 in FIG. 1), including a series of vehicle mission waypoints in the form of, e.g., a discrete velocity or position time-series (e.g., represented by the open circles in panels I, II, and III of FIG. 2A). The mission planner may be configured to provide this initial coarse mission plan or objective, which may subsequently be refined to generate a scheduled optimal control sequence. The input from the mission planner to node B may also include context information including, e.g., the state constraints (such as minimum and maximum (or lower and upper constraints of) vehicle speed & position at each future time point for the prediction horizon) that can relate to safety (for example to avoid collision, or overspeeding, or by traffic rules), labeled with acceptable risk levels (e.g., harshness levels). In some embodiments, the input from the mission planner to node B may include a task type. The input to node B may further include information of vehicle states from the vehicle parameter estimation (VPE) module (e.g., vehicle parameter estimation module 110 as illustrated in FIG. 1). Node B may be a motion controller, e.g., a primary longitudinal controller.

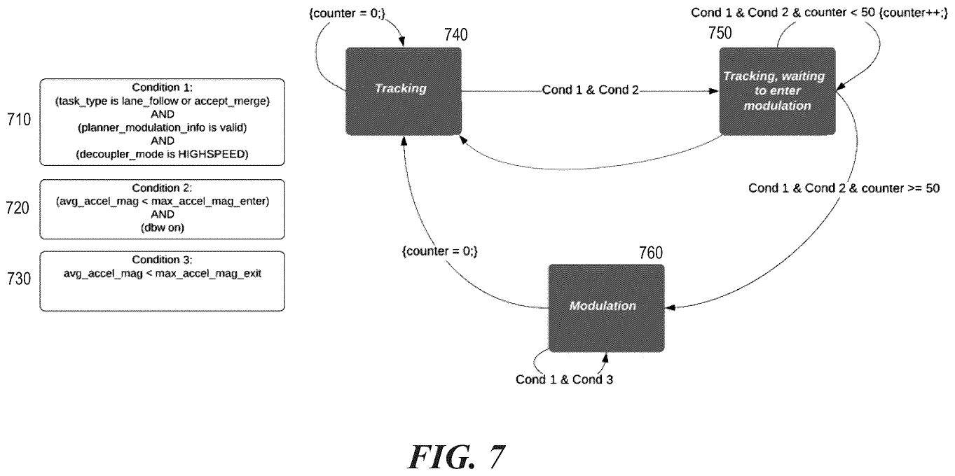

At 330, the process 300A may determine longitudinal dynamic control information (including, e.g., control mode) and the prediction horizon (e.g., 5 seconds, 10 seconds). In some embodiments, the decision in control mode may be based, at least in part, on information completeness. For example, if all information needed for bounded tracking mode is received, the bounded tracking mode may be selected; otherwise, the precise tracking mode may be selected. Additional description regarding the deternation of the control mode and prediction horizon may be found elsewhere in the present disclosure. See also, e.g., FIG. 7 and relevant description thereof.

At 340, the process 300A may obtain synchronized information including values of one or more operation parameters including, e.g., context information, reference information, etc. In some embodiments, the context information may include, e.g., vehicle speed information at that time, a road grade, the mechanical capacity of the vehicle). In some embodiments, the context information may include state constraints (e.g., speed upper and lower constraints, position upper and lower constraints) and their corresponding harshness levels. See, e.g., relevant description with respect to FIG. 2C. At 340, the process 300A may process the input to node B to generate the common dependencies (e.g., road grade, speed and position references).

At 350, the process 300A may input the information obtained at 340 into an uncertainty model. In some embodiments, the uncertainty model may include a machine learning model trained to predict substantially in real time an uncertainty degree of the reference information. The uncertainty model may be trained offline or online. The uncertainty model may include a multivariate model trained based on balanced training data that represent multiple types of events relating to the operation of the vehicle or the path along which the vehicle operates. The types of events may include, e.g., a hard braking event, a soft braking, a lane changing, a following, a cutting in of another vehicle or object, etc. More descriptions regarding the uncertainty model may be found in, e.g., Gaussian Process Model of Uncertainty in Safety-Critical Autonomous Driving, 2023 IEEE 26th International Conference on Intelligent Transportation Systems (ITSC), P. Kolaric, et al., U.S. Provisional Application No. 63/502,578 filed on May 16, 2023, and U.S. application Ser. No. ______ (Attorney Docket No.: 128000/8260.US01) filed on even date, the contents of each of which are incorporated by reference.

The process 300A may determine a tolerable range of the operation parameter at a specific time point based on the reference information (e.g., waypoints from the mission planner) and the uncertainty degree (see also 355 in FIG. 3B). The uncertainty degree may be used to determine a tolerable range of an operation parameter at a waypoint (or time point). The tolerable range of the operation parameter may be a range between the control soft constraints illustrated as two dashed lines in FIG. 4, or a range between the two dashed lines denoted as control upper bound and control lower bound in FIG. 2D), and a modulation bandwidth. A modulation width may indicate a safety margin associated with the operation parameter at or in a vicinity of the time point. In some embodiments, a modulation bandwidth corresponding a time point may indicate or relate to a difference between a tolerable range and a state constraint (e.g., a control hard constraint as described elsewhere in the present document) at the time point of the plurality of time points. See also, e.g., FIG. 4 and relevant description thereof. The count of the waypoints (or time points) included in the planning relates to the determined prediction horizon. Based on the context and safety margin, at 360, the process 300A may determine which control mode (e.g., a tracking-based control mode, or a bounded tracking-based control mode (or referred to as constraint-defined control, modulation or state modulation-based control mode)) to select. If the tracking-based control mode is selected, the process at 370 may assign objective weights based on static configuration. If the modulation-based control mode is selected, the process at 380 may assign objective weights (e.g., penalty weights relating to corresponding modulation widths) adaptively based on the modulation bandwidths (indicating e.g., a difference between a tolerable range and a constraint at each of the waypoints (or time points) of the prediction horizon. At 390, the process 300A may input the objective weights determined in 370 or 380 and the reference information into a longitudinal dynamic MPC to determine primary (or referred to as low-level) control commands (or referred to as control instructions) according to which the vehicle is to operate along a path/road.

FIG. 3B shows a process 300B for controlling a vehicle according to some embodiments of the present document. Like reference numerals indicate like opeations. The process 300B is similar to the process 300A. At 355, the process 300B may blend received reference information, uncertainty degrees, and/or context information to generate control soft constraints (e.g., tolerable ranges) of an operation parameter (regarding a state of the vehicle) for respective time points within the prediction horizon. See also FIGS. 5 and 6 and relevant description thereof.

FIG. 4 shows a flowchart of a process for determining an optimized trajectory based on most recent knowledge of future states (at various waypoints or time points, shown by previous optimal trajectory in FIG. 4) according to some embodiments of the present document. The previous optimal trajectory obtained from this controller may be considered as the most recent knowledge of future states, which is provided for illustration purposes and not intended to be limiting. For example, planner waypoints generated from the kinematic model may also be used as most recent knowledge of future states. The arrows at the ends of the lines in FIG. 4 indicate the direction in which a vehicle travels. The top and bottom solid lines denoted as “spd_UB_ctrl_hard” and “spd_LB_ctrl_hard,” respectively, illustrate the upper and lower limits of a constraint relating to an operation parameter (e.g., speed as illustrated in FIG. 4). The two dashed lines denoted as “spd_UB_ctrl_soft” and “spd_LB_ctrl_soft,” respectively, which are inward from and immediately next to the top and bottom solid lines, respectively, illustrate the upper and lower limits (or bounds) of the operation parameter determined by taking into consideration context information including, e.g., state constraints and uncertainties, as discussed elsewhere in the present document. The two dashed lines indicate the upper and lower limits (or bounds) of control soft constraints. More information regarding the determination thereof may be found in FIG. 5 and the description thereof. The band between the top and bottom solid lines illustrates the intervals or ranges regarding a range of values of the operation parameter with a 95% confidence level in which the safety of the vehicle is considered ensured. The arrows between the bottom solid line (denoted as “spd_LB_ctrl_hard”) and the bottom dashed curve (denoted as “spd_LB_ctrl_soft”) illustrate a modulation bandwidth indicating the varying safety margins at different time points. Based on the safety margins, penalty weights may be determined. Accordingly, an optimal trajectory (not shown in FIG. 4) may be determined within the band according to bounded tracking. The optimal trajectory so determined is different from the reference trajectory indicated using the straight solid line in the middle by directly connecting “planner waypoints.” In some embodiments, one or more techniques including, e.g., move blocking, may be employed to enforce a constant control command over a certain period within the prediction horizon, and reduce the dimensionality of the underlying optimization problem to speed up computation.

FIG. 5 shows a flowchart of a process for selecting a soft constraint (or control soft constraint) according to some embodiments of the present document. A selected planner constraint may be referred to as a control hard constraint, and may be considered as “should not violate” in control. The uncertainty predictor may use a control hard constraint as input, apply an uncertainty gap (e.g., an uncertainty degree determined based on input of an uncertainty predictor as described elsewhere in the present document), and generate a robust hard constraint (e.g., the output of 350 as illustrated in FIG. 3B). After this, planner reference waypoints (e.g., mission waypoints as described elsewhere in the present document) and the robust hard constraint may be blended to generate a control soft constraint (e.g., 355 as illustrated in FIG. 3B). The control soft constraints (or referred as soft constraints for brevity) so determined may provide tolerable ranges of an operation parameter that describes a state of the vehicle at various time points with the prediction horizon. The control soft constraints may be introduced to facilitate the control decision. For example, such control soft constraints may constitute the actual input to an optimized longitudinal dynamic MPC controller (e.g., bounded tracking-based controller as described elsewhere in the present document).

For the prediction horizon, if at least one reference value at a time point violates a corresponding control hard constraint (e.g., a primary constraint) for that time point, the soft constraint may be set as the stricter of the reference value or the control hard constraint as illustrated in panel I of FIG. 5. For example, a control hard constraint may be equivalent to a control soft constraint corresponding to a high penalty weight for a specific time point. If none of the reference values at the time points within the prediction horizon violates the corresponding control hard constraints, the soft constraint for a time point within the prediction horizon may be set as the robust hard constraint determined based on but different from the control hard constraint information as illustrated in panel II of FIG. 5. For example, for a specific time point, a robust hard constraint may be equivalent to a control hard constraint modified by the corresponding uncertainty degree. This selection may ensure that a reference value of the operation parameter is a feasible solution for not violating a control hard constraint (e.g., a primary constraint). The control soft constraint so determined may satisfy both the control hard constraint and relevant reference information.

FIG. 6 shows an example of selecting a soft constraint according to the flow shown in FIG. 5. Curve A shows reference information (denoted as ekf_vx), curve B (a solid line with crosses) shows control soft constraints (denoted as control_soft_spd_ub), curve C shows a robust hard control (denoted as robust_hard_spd_ub), and curve D shows control hard constraints (denoted as planning_spd_ub). In the portion between points a and b of curve A along the prediction horizon, the reference values in curve A exceed (or violate) the control hard constraints in curve D. Accordingly, the flow in panel I of FIG. 5 is followed. In this case, a control soft constraint is the stricter of the reference value or the control hard constraint for a specific time point. Accordingly, a first portion of curve B to the left of point a coincides with curve A, and a second portion of curve B between points a and b coincides with curve D.

FIG. 7 shows an example flowchart of a process for selecting control modes according to some embodiments of the present document. The selection between the tracking-based control mode and the bounded tracking-based control mode (or referred to as state modulation mode or modulation mode) may be made based on one or more conditions. Example conditions may include Condition 1 in 710, Condition 2 in 720 and Condition 3 in 730 relating to the preview acceleration amount (predicted acceleration in the prediction horizon). Condition 1 as illustrated is an AND operation of three items including (1) a traffic condition or task type allowed (e.g., a lane following, accepting merge), (2) planning information (or referred to as planner modulation information) is sufficient and/or valid, and (3) the decoupler mode is at HIGHSPEED. Condition 2 as illustrated is also used for determination as to whether to enter the modulation mode. Condition 2 is deemed true if the vehicle is in autonomy and if averaged requested acceleration magnitude in the next few seconds (e.g., 3 seconds, 4 seconds, 5 seconds) within the prediction horizon is smaller than the entering threshold (denoted as max_accel_mag_enter in FIG. 7). Condition 3 as illustrated is to check whether the control of the vehicle may remain in the modulation state by, e.g., checking whether the averaged acceleration magnitude is smaller than the exiting threshold (denoted as max_accel_mag_exit in FIG. 7).

The duration of the tracking-based control mode in operation may be tracked based on, e.g., a counter. A low count may indicate that a critical or dangerous traffic condition has occurred recently. In some embodiments, a certain period needs to lapse before the activation of the bounded tracking-based control mode in 760. When the control mode switches from bounded tracking to tracking, the counter may be reset as indicated in 740. If at least one condition for switching from tracking is not satisfied, the counter does not change and the tracking-based control mode is employed in 740. If both Condition 1 and Condition 2 favoring switching from tracking to bounded tracking are satisfied, the tracking-based control mode is still in use but the system is awaiting to switch to the bounded tracking-based (modulation-based) control mode by advancing the counter in 750. When Condition 1 and Condition 2 are both satisfied and the counter reaches a threshold (e.g., 50 indicating that a sufficient period of time has elapsed since a last event under the tracking-based control mode), the control mode switches from tracking to bounded tracking in 760, and remains so until a triggering event occurs.

In some embodiments, the process may include one or more measure to avoid or reduce unjustified changes in control modes, often referred to as decision flips. For example, the entering threshold (denoted as max_accel_mag_enter in FIG. 7) may be set to be smaller than the exiting threshold (denoted as max_accel_mag_exit in FIG. 7). That is, a stricter entering condition may be employed and the vehicle remain in the modulation mode until acceleration gets much larger. Additionally or alternatively, the “tracking, waiting to enter modulation” state is included, so the modulation mode is entered if the required conditions are satisfied in every frame in the past few (e.g., 40, 50, 60, etc.) frames or time period (e.g., 2 seconds, 3 seconds, etc.). Both measures may help filter out the periods when state transitioning conditions are met shortly or due to noise, and thus can avoid undesired or unjustified decision flips.

The control horizon may be set after the control mode is determined. For example, if the control of the vehicle is in tracking mode, the prediction horizon may be set to be a first time duration (e.g., 3 seconds, 4 seconds, 5 seconds, etc.). Data show that this duration (e.g., 4 seconds) is enough to generate acceptable tracking behavior. As another example, if the control of the vehicle is in modulation mode, the prediction horizon may be set to be a second time duration (e.g., 8 seconds, 10 seconds, etc.). The second duration may be set based on one or more factors including available waypoint reference from the planner, computation time that may grow with the duration, or the like, or a combination thereof.

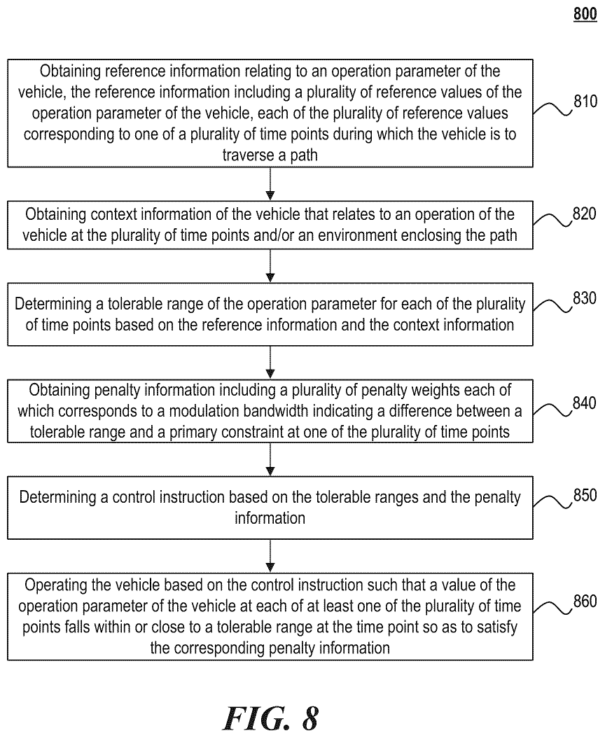

FIG. 8 illustrates a process 800 for controlling a vehicle according to some embodiments of the present document. In 810, the process 800 may obtain reference information relating to an operation parameter of the vehicle, the reference information including a plurality of reference values of the operation parameter of the vehicle. In some embodiment, each of the plurality of reference values may correspond to one of a plurality of time points during which the vehicle is to traverse a path. In some embodiments, the reference information may include a value of the operation parameter at a prior time point that precedes each of the plurality of time points. In 820, the process 800 may obtain context information of the vehicle that relates to an operation of the vehicle at the plurality of time points and an environment enclosing the path. In some embodiments, the context information may include a state constraint (e.g., a mechanical capacity of the vehicle), environmental information of the environment in which the vehicle operates, or the like, or a combination thereof. In 830, the process 800 may determine a tolerable range of the operation parameter for each of the plurality of time points based on the reference information and the context information. In some embodiments, the process 800 may determine a tolerable range of the operation parameter for each of the plurality of time points based on the reference information and the context information by a process including: inputting the reference information and the context information into an uncertainty model, the uncertainty model comprising a machine learning model trained to predict substantially in real time a tolerable range of the operation parameter at a specific time point based on at least one of a value of the operation parameter at a prior time point that precedes the specific time point, the mechanical capacity of the vehicle, or the environmental information.

In 840, the process 800 may obtain penalty information. In some embodiments, the penalty information may include a plurality of penalty weights each of which may correspond to a modulation bandwidth. The modulation bandwidth may relate to a difference between a tolerable range and a primary constraint at one of the plurality of time points. For example, the modulation bandwidth at a waypoint within a prediction horizon may be determined based on a difference between the upper bound of a primary constraint (e.g., a control hard constraint) and the upper bound of a tolerable range (e.g., control soft constraint as illustrated in FIG. 4) at the waypoint, or a difference between the lower bound of a primary constraint (e.g., a control hard constraint) and the lower bound of a tolerable range (e.g., control soft constraint as illustrated in FIG. 4) at the waypoint. The modulation bandwidth at different waypoints within the prediction horizon may vary. Sec, e.g., FIG. 4. In 850, the process 800 may determine a control instruction based on the tolerable ranges and the penalty information. In some embodiments, the process 800 may take further into consideration the reference information, in addition to the tolerable ranges and the penalty information, in determining the control instruction. In 860, the process 800 may operate the vehicle based on the control instruction. For example, the process 800 may transmit the control instruction to a vehicle control interface through which an operation of the vehicle may be actuated. In some embodiments, if the vehicle operates according to the control instruction, the value of the operation parameter at each of the plurality of time points may fall within or close to a tolerable range at the corresponding time point such that the corresponding penalty information is satisfied.

Embodiments of the disclosed technology provide, amongst other features and benefits, the following advantages:

Future state targets: The determined vehicle control actuations are optimal with respect to future control target trajectories and future vehicle state projections, whereas existing solutions can only determine vehicle control actuations in response to an instantaneous singular set of control targets and control state errors.

Multiple control objectives: The defined control law can be optimized for a plurality of objectives, such as tracking accuracy, motion smoothness, actuation cost (fuel economy and brake preserving), with contradictory objectives being self-resolved by the control solver, and with objectives not in need of optimization redefined into state constraints, such as vehicle stability and collision avoidance.

Constraint compliance: The determined control actuations that maintain vehicle states remain within the required constraint space when the constraints are feasible, such as vehicle stopping position, target speed in a finite amount of time, maximum/minimum vehicle driving speed, maximum/minimum vehicle acceleration, inter-vehicle distance requirement, etc. For situations when the constraints are infeasible, the described embodiments relax the infeasible constraint to a minimum amount while maximizing vehicle actuation capability usage, to ensure the existence of a solution while minimizing the risk caused by constraint violation.

In contrast, existing solutions cannot ensure a vehicle motion state stays within a required constraint space with a limited amount of actuation capability. Actuation optimality: The control actuation decisions are optimized to a future horizon of the driving mission and projected vehicle states and are augmented by the SAE L4 autonomous driving perception and planning system's capability of handling multiple projects under complicated traffic contexts. Furthermore, the vehicle control actuations are optimized for a plurality of performance criteria and are optimized to balance contradictory objectives.

Application scenarios: The constrained motion capability and upper stream information handling advantageously enables coverage for the entire range of traffic scenarios of SAE L4 autonomous driving, which can involve intense traffic vehicle interactions and high control accuracy requirements in complicated real-world urban driving scenarios. In contrast, existing solutions use radar, LIDAR and camera systems that can only handle simple traffic contexts, which are typically limited to conventional cruise control or adaptive cruise control scenarios that are normally restricted to highway driving.

Adaptive model parameters: The generation of the vehicle control actuation self-optimizes for any given vehicle model parameter set in a continuous range, as long as the input parameter set is within a reasonable range, thereby ensuring that performance does not degrade as the model parameters change. Furthermore, running an online vehicle model parameter adaptation and/or estimation process improves the derived solutions.

In contrast, existing solutions typically do not use MPC, and rely on an offline calibration of control parameters, which results in being able to accept only a limited number of vehicle system parameters that do not represent the continuously changing vehicle longitudinal dynamic response parameters under various sources of unmeasurable disturbances in real world. As a result, the control performance of existing solutions will degrade when current parameters fall outside or in between the predefined system parameters and calibration sets.

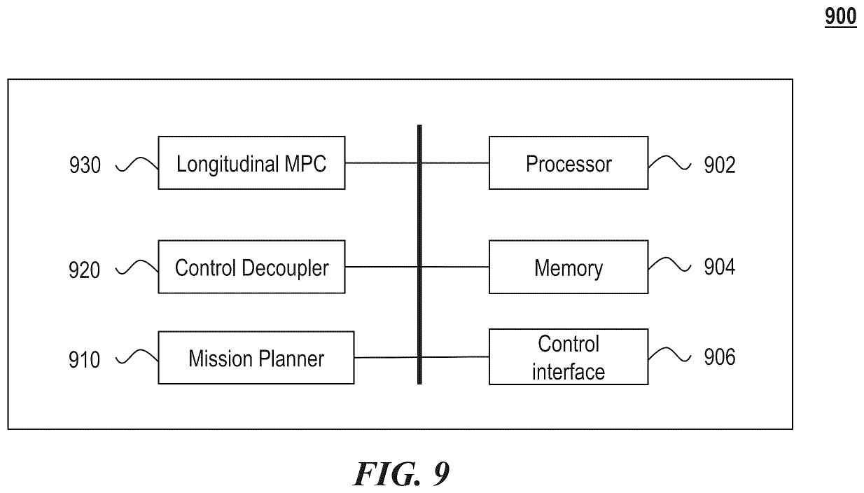

FIG. 9 shows an example of a hardware platform 900 that can be used to implement some of the techniques described in the present document. For example, the hardware platform 900 may implement process 800 or may implement the various modules described herein. The hardware platform 900 may include a processor 902 that can execute code to implement a method. The hardware platform 900 may include a memory 904 that may be used to store processor-executable code and/or store data. The hardware platform 900 may further include a control interface 906. For example, the control interface 906 may implement one or more intra-vehicular communication protocols. The hardware platform may further include a mission planner 910, a control decoupler 920 and a longitudinal MPC 930. In some embodiments, some portion or all of the mission planner 910, the control decoupler 920 and/or the longitudinal MPC 930 may be implemented in the processor 902. In other embodiments, the memory 904 may comprise multiple memories, some of which are exclusively used by the mission planner, control decoupler and/or longitudinal MPC.

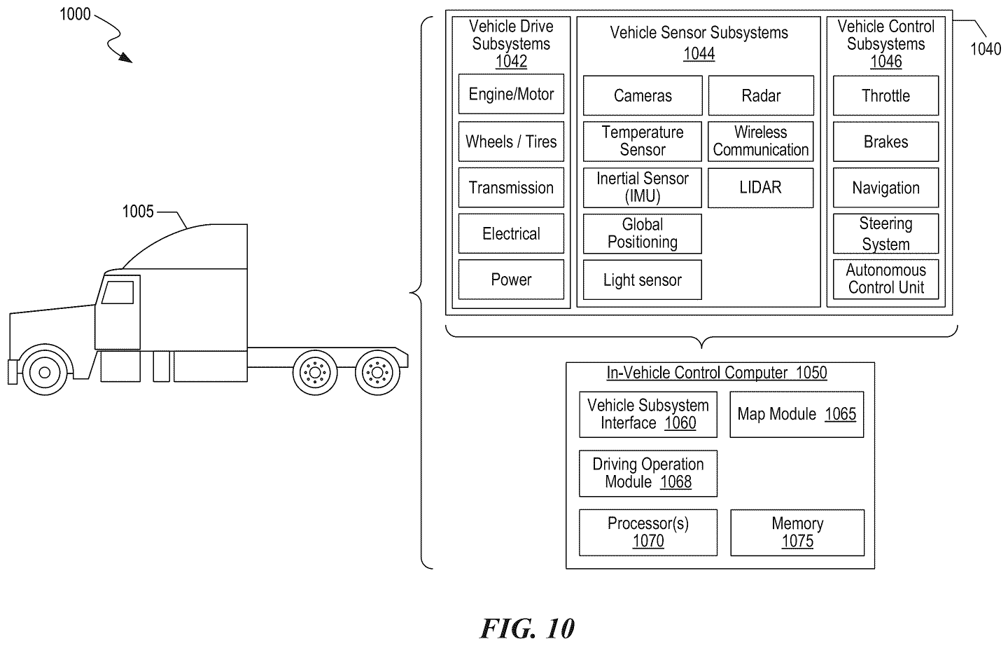

FIG. 10 illustrates a block diagram of an example vehicle ecosystem according to some embodiments of the present document. Embodiments of systems and methods of the present document may be implemented on system 1000 as illustrated. The system 1000 may include an autonomous vehicle 1005, such as a tractor unit of a semi-trailer truck. The autonomous vehicle 1005 may include a plurality of vehicle subsystems 1040 and an in-vehicle control computer 1050. The plurality of vehicle subsystems 1040 can include, for example, vehicle drive subsystems 1042, vehicle sensor subsystems 1044, and vehicle control subsystems 1046. FIG. 10 shows several devices or systems being associated with the autonomous vehicle 1005. In some embodiments, additional devices or systems may be added to the autonomous vehicle 1005, and in some embodiments, some of the devices or systems shown in FIG. 10 may be removed from the autonomous vehicle 1005.

An engine/motor, wheels and tires, a transmission, an electrical subsystem, and/or a power subsystem may be included in the vehicle drive subsystems 1042. The engine/motor of the autonomous truck may be an internal combustion engine (or gas-powered engine), a fuel-cell powered electric engine, a battery powered electric engine/motor, a hybrid engine, or another type of engine capable of actuating the wheels on which the autonomous vehicle 1005 (also referred to as vehicle 1005 or truck 1005) moves. The engine/motor of the autonomous vehicle 1005 can have multiple engines to drive its wheels. For example, the vehicle drive subsystems 1042 can include two or more electrically driven motors.

The transmission of the vehicle 1005 may include a continuous variable transmission or a set number of gears that translate power created by the engine of the vehicle 1005 into a force that drives the wheels of the vehicle 1005. The vehicle drive subsystems 1042 may include an electrical system that monitors and controls the distribution of electrical current to components within the vehicle drive subsystems 1042 (and/or within the vehicle subsystems 1040), including pumps, fans, actuators, in-vehicle control computer 1050 and/or sensors (e.g., cameras, LiDARs, RADARs, etc.). The power subsystem of the vehicle drive subsystems 1042 may include components that regulate a power source of the vehicle 1005.

Vehicle sensor subsystems 1044 can include sensors that are used to support general operation of the autonomous truck 1005. The sensors for general operation of the autonomous vehicle may include, for example, one or more cameras, a temperature sensor, an inertial sensor, a global positioning system (GPS) receiver, a light sensor, a LiDAR system, a radar system, and/or a wireless communications system.

The vehicle control subsystems 1046 may include various elements, devices, or systems including, e.g., a throttle, a brake unit, a navigation unit, a steering system, and an autonomous control unit. The vehicle control subsystems 1046 may be configured to control the operation of the autonomous vehicle, or truck, 1005 as a whole and the operation of its various components. The throttle may be coupled to an accelerator pedal so that a position of the accelerator pedal can correspond to an amount of fuel or air that can enter the internal combustion engine. The accelerator pedal may include a position sensor that can sense a position of the accelerator pedal. The position sensor can output position values that indicate the positions of the accelerator pedal (e.g., indicating the amount by which the accelerator pedal is actuated.)

The brake unit can include any combination of mechanisms configured to decelerate the autonomous vehicle 1005. The brake unit can use friction to slow the wheels of the vehicle in a standard manner. The brake unit may include an anti-lock brake system (ABS) that can prevent the brakes from locking up when the brakes are applied. The navigation unit may be any system configured to determine a driving path or route for the autonomous vehicle 1005. The navigation unit may additionally be configured to update the driving path dynamically based on, e.g., traffic or road conditions, while, e.g., the autonomous vehicle 1005 is in operation. In some embodiments, the navigation unit may be configured to incorporate data from a GPS device and one or more predetermined maps so as to determine the driving path for the autonomous vehicle 1005. The steering system may represent any combination of mechanisms that may be operable to adjust the heading of the autonomous vehicle 1005 in an autonomous mode or in a driver- controlled mode of the vehicle operation.

The autonomous control unit may include a control system (e.g., a computer or controller comprising a processor) configured to identify, evaluate, and avoid or otherwise negotiate potential obstacles in the environment of the autonomous vehicle 1005. In general, the autonomous control unit may be configured to control the autonomous vehicle 1005 for operation without a driver or to provide driver assistance in controlling the autonomous vehicle 1005. In some example embodiments, the autonomous control unit may be configured to incorporate data from the GPS device, the radar, the LiDAR, the cameras, and/or other vehicle sensors and subsystems to determine the driving path or trajectory for the autonomous vehicle 1005.

An in-vehicle control computer 1050, which may be referred to as a vehicle control unit or VCU, can include, for example, any one or more of: a vehicle subsystem interface 1060, a map data sharing module 1065, a driving operation module 1068, one or more processors 1070, and/or memory 1075. This in-vehicle control computer 1050 may control many, if not all, of the operations of the autonomous truck 1005 in response to information from the various vehicle subsystems 1040. The memory 1075 may contain processing instructions (e.g., program logic) executable by the processor(s) 1070 to perform various methods and/or functions of the autonomous vehicle 1005, including those described in this patent document. For instance, the data processor 1070 executes the operations associated with vehicle subsystem interface 1060, map data sharing module 1065, and/or driving operation module 1068. The in-vehicle control computer 1050 can control one or more elements, devices, or systems in the vehicle drive subsystems 1042, vehicle sensor subsystems 1044, and/or vehicle control subsystems 1046. For example, the driving operation module 1068 in the in-vehicle control computer 1050 may operate the autonomous vehicle 1005 in an autonomous mode in which the driving operation module 1068 can send instructions to various elements or devices or systems in the autonomous vehicle 1005 to enable the autonomous vehicle to drive along a determined trajectory. For example, the driving operation module 1068 can send instructions to the steering system to steer the autonomous vehicle 1005 along a trajectory, and/or the driving operation module 1068 can send instructions to apply an amount of brake force to the brakes to slow down or stop the autonomous vehicle 1005.

The map data sharing module 1065 can be also configured to communicate and/or interact via a vehicle subsystem interface 1060 with the systems of the autonomous vehicle. The map data sharing module 1065 can, for example, send and/or receive data related to the trajectory of the autonomous vehicle 1005 as further explained in Section II. The vehicle subsystem interface 1060 may include a software interface (e.g., application programming interface (API)) through which the map data sharing module 1065 and/or the driving operation module 1068 can send or receive information to one or more devices in the autonomous vehicle 1005.

The memory 1075 may include instructions to transmit data to, receive data from, interact with, or control one or more of the vehicle drive subsystems 1042, vehicle sensor subsystems 1044, or vehicle control subsystems 1046. The in-vehicle control computer (VCU) 1050 may control the operation of the autonomous vehicle 1005 based on inputs received by the VCU from various vehicle subsystems (e.g., the vehicle drive subsystems 1042, the vehicle sensor subsystems 1044, and the vehicle control subsystems 1046). The VCU 1050 may, for example, send information (e.g., commands, instructions or data) to the vehicle control subsystems 1046 to direct or control functions, operations or behavior of the autonomous vehicle 1005 including, e.g., its trajectory, velocity, steering, braking, and signaling behaviors. The vehicle control subsystems 1046 may receive a course of action to be taken from one or more modules of the VCU 1050 and may, in turn, relay instructions to other subsystems to execute the course of action.

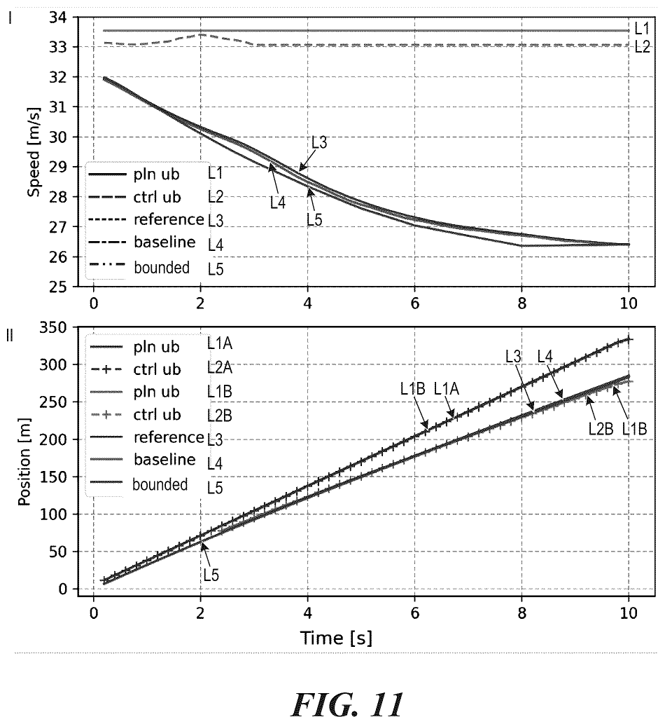

FIGS. 11-14 and Table 1 below include simulated test results and actual road test results of the baseline control framework (the tracking-based control mode, denoted as “baseline” in FIG. 11) and the bounded tracking based control mode (referred to as “bounded” in FIG. 11) to evaluate the performance and illustrates technical improvements of the bounded tracking-based control framework according to some embodiments of the present document. In the simulations and road tests whose results are illustrated herein, the target of the longitudinal controller includes satisfying traffic constraints and improving driving smoothness when possible. For both control frameworks being assessed, 10 seconds waypoints and prediction of the traffic context information is provided by a planner module. For the baseline control framework, a control preview horizon is set to 4 seconds. It has been observed in the exemplary assessments that not much performance improvement is seen by using a longer preview horizon. For the bounded tracking-based control framework, the whole 10 seconds preview horizon is used.

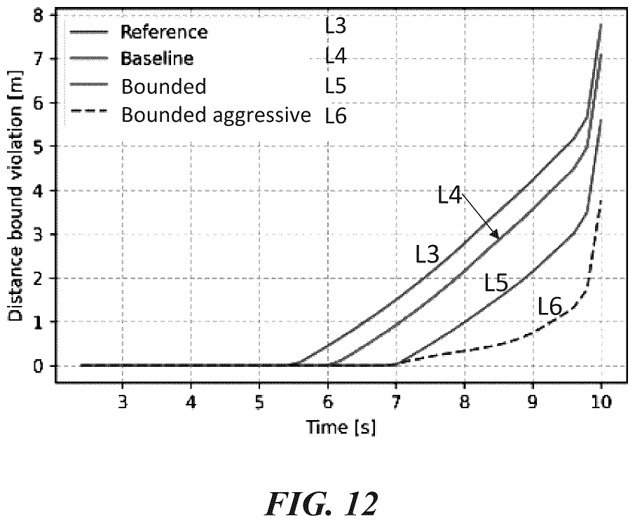

As a case study by simulation, a single frame is extracted from the test data on the basis of which the baseline controller as well as the bounded tracking-based controller are deployed to compare their performances. Results are shown in FIGS. 11 and 12.

FIG. 11 shows a case study by simulating a deceleration scenario with a tight position constraint according to some embodiments of the present document. FIG. 11 shows the input state reference and constraints context provided to the controller framework, along with optimized sequences by the baseline and the bounded tracking-based control framework. The top plot in panel I displays the speed sequences and the bottom plot in panel II shows the position sequences. FIG. 11 depicts a deceleration scenario with a small hump in the speed reference (L3 in panel I) at or around 3 s. For both states (speed and position), the dashed lines labelled “Ctrl ub” (L2 in panel I, L2A and L2B in panel II) are the control bounds, which are generated based on the planner bounds “Pln ub” (L1 in panel I, L1A and L1B I panel II). For example, for speed, the “Ctrl ub” may be determined by subtracting “Pln ub” by the speed uncertainty Δ̅v̅, i.e., the gap between solid line and dashed line (between L1 and L2 in panel I). It is evident from FIG. 11 that the control sequence generated by the bounded tracking-based controller has a better smoothness within the preview horizon by removing the hump (L5 in panel I), while the sequence from the baseline controller closely follows the speed reference and still contains a hump (L4 in panel I), which may adversely affect the driving smoothness performance.

Another notable difference is that the speed from the proposed controller is lower than that of the baseline controller (L5 below L4 in panel I). This discrepancy may be because of the awareness of constraints in the proposed controller. Panel I of FIG. 11 shows that the speed constraints generated from the road speed limit are loose and remain inactive, indicated by, e.g., the gap between L2 and L3. However, there is a tight position constraint (curve L1B in the bottom plot in panel II of FIG. 11) that affects the result of the proposed controller (L5 in panel II).

FIG. 12 illustrates distance constraints violation amounts results from different controllers according to some embodiments of the present document. The constraint is not fully satisfied by the reference (L3 in FIG. 12), leading to a positive violation after 5 s in the horizon (or referred to as the preview horizon) shown in FIG. 12. FIG. 12 also illustrates the violation amounts resulted from optimized state sequences generated from the baseline (L4) and proposed controller (L5). The baseline controller is only aware of the reference and thus does not account for the constraints, and the violation curve in L4 labelled “Baseline” is obtained through post-processing. FIG. 12 demonstrates a reduction in the amount of violation by using the proposed framework (L5). In this case, complete avoidance of the violation may be achieved by adjusting the harshness level with respect to the violation. With a more aggressive harshness setting, the bounded tracking-based controller may generate an optimized state sequence that satisfies the constraint with less violation across the horizon (shown by dashed curve L6 labelled “Bounded aggressive”).

Both the baseline control framework (i.e. tracking-based control framework) and the bounded tracking-based control framework have been validated on the autonomous driving system on class-8 trucks in real traffic of Arizona and Texas, USA. Both frameworks have been tested with vast road grade ranges in Arizona and Texas, multiple vehicle platforms, and a complex variety of traffic conditions, providing massive and sufficient data for performance evaluation.

An aggregated analysis has been performed after processing in total over 30,000 miles of highway driving data with baseline framework and the bounded tracking-based controller framework.

Jerk magnitude has been chosen as the performance metric to evaluate vehicle smoothness performance. Different operation conditions can have inconsistent jerk performance. Vehicle speed and acceleration demand may constitute two significant factors that may affect performance consistency. For instance, high jerkiness is more likely to occur when acceleration demand is high. On highway, dense traffic situations with lower speed is more likely to cause high acceleration demand and high jerkiness, since otherwise the vehicle may travel at the speed limit. To perform a fair comparison of jerk performance, the dataset has been balanced such that the sampled data for both cases has a substantially same distribution over speed and acceleration demands.

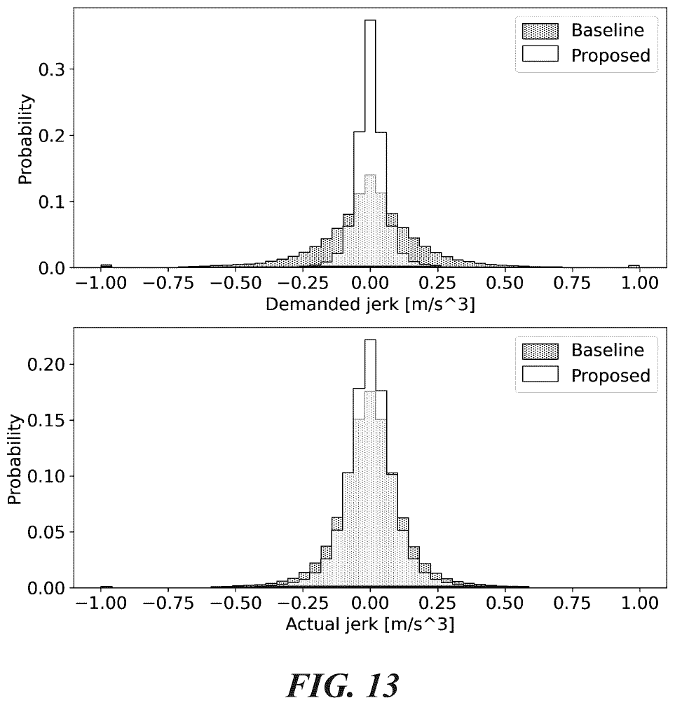

FIG. 13 shows the comparison of histograms of jerk in control acceleration demand (panel I) and in actual vehicle acceleration (panel II) using the baseline and the bounded tracking-based control framework according to some embodiments of the present document. Here the actual acceleration is an estimation of the vehicle longitudinal acceleration generated from an onboard vehicle state estimator. As illustrated in FIG. 13, driving data obtained with the bounded tracking-based control framework shows more centered jerk and demonstrates superior smoothness performance. With the bounded tracking-based control framework, 90% of the demanded jerk is within ±0.1 m/s³, while the number is ±0.3 m/s³ for the baseline control framework. The 99th percentile values for the bounded tracking-based and the baseline control frameworks are ±0.3 m/s³ and ±0.8 m/s³, respectively. The actual jerk illustrated in panel II exhibits similar comparison. The results indicate the capability of the bounded tracking-based control framework to provide smoother driving behavior than the baseline (tracking) based control framework.

Another evaluation metric is state constraints satisfaction using the bounded tracking-based controller framework. Here the relationship between actual longitudinal speed and the speed constraints horizons requested from the preceding timeframe has been analyzed.

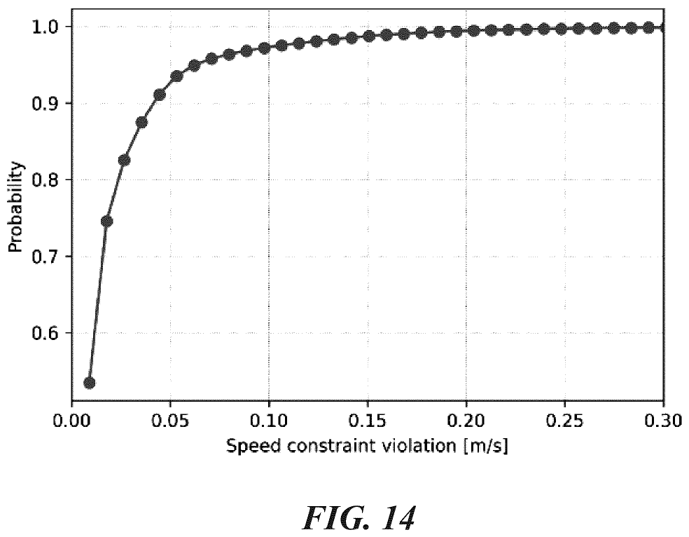

For over 90% of the events the speed upper bound violation is less than 0.01 m/s. For the remaining 10%, the cumulative distribution of violation amount is plotted in FIG. 14. Overall, less than 1% of the events has speed constraint violation of larger than 0.05 m/s, and the 99.995 th percentile of the violations is 0.43 m/s or 1 mph. These results indicate that the bounded tracking-based (or referred to as constraint-defined) controller framework effectively satisfies the state constraints.

The computation time performance is illustrated in Table 1. Both the baseline and the bounded tracking-based control frameworks use a same custom quadratic programming solver in the computation time performance assessment.

TABLE 1

| Computation | Baseline Control | Bounded Tracking-based |
|---|---|---|
| time [ms] | Framework | Control Framework |
| Average | 1.251 | 7.534 |
| 99% | 1.921 | 12.575 |
| 99.99% | 2.921 | 18.148 |

Some example technical solutions are implemented as described below.
1. A method for controlling a vehicle, comprising: obtaining reference information relating to an operation parameter of the vehicle, the reference information including a plurality of reference values of the operation parameter of the vehicle, each of the plurality of reference values corresponding to one of a plurality of time points during which the vehicle is to traverse a path; obtaining context information of the vehicle that relates to an operation of the vehicle at the plurality of time points and an environment enclosing the path; determining a tolerable range of the operation parameter for each of the plurality of time points based on the reference information and the context information; obtaining penalty information including a plurality of penalty weights each of which corresponds to a modulation bandwidth indicating a difference between a tolerable range and a constraint at one of the plurality of time points; determining a control instruction based on the tolerable ranges and the penalty information; and operating the vehicle based on the control instruction such that a value of the operation parameter of the vehicle at each of at least one of the plurality of time points falls within a tolerable range at the time point. The operation parameter of the vehicle in the reference information may be a mission waypoint described by, e.g., a vehicle speed or velocity, a vehicle position, etc. The context information may refer to a set of data and/or factors to which the vehicle is subjected in an actual operation of the vehicle guided by the reference information. Example context information may include the state of the vehicle at a prior time point or position, the mechanical capacity of a portion of the vehicle (e.g., engine, brake), a road condition (e.g., slippery road), the behavior of a vehicle or object in a vicinity of the vehicle), or the like, or a change or a combination thereof. The constraint may be a state constraint (e.g., vehicle speed, vehicle position) as part of the context information. For example, the constraint may be a vehicle speed constraint or a vehicle position constraint determined by the vehicle mission planner (e.g., the mission planning module 140 as illustrated in FIG. 1). The constraint may be a control hard constraint. See, e.g., FIGS. 5 and 6 and relevant description thereof.
2. The method of any one or more of the solutions herein, wherein: the reference information comprises a value of the operation parameter at a prior time point that precedes each of the plurality of time points, the context information comprises at least one of a mechanical capacity of the vehicle or environmental information of the environment enclosing the path, and determining a tolerable range of the operation parameter for each of the plurality of time points based on the reference information and the context information comprises: inputting the reference information and the context information into an uncertainty model, the uncertainty model comprising a machine learning model trained to predict substantially in real time a tolerable range of the operation parameter at a specific time point based on at least one of a value of the operation parameter at a prior time point that precedes the specific time point, the mechanical capacity of the vehicle, or the environmental information. Sec, e.g., FIGS. 5 and 6 and relevant description regarding the determination of the tolerable ranges in connection with the uncertainty prediction.
3. The method of any one or more of the solutions herein, further comprising: determining that a value of the operation parameter violates the constraint at a specific time point of the plurality of time points; adjusting the penalty information with respect to the specific time point or at least one time point following the specific time point; adjusting the control instruction based on the adjusted penalty information; and operating the vehicle based on the adjusted control instruction such that the value of the operation parameter of the vehicle changes so as to satisfy the constraint or that a value of the operation parameter at a subsequent time point satisfies the constraint.
4. The method of any one or more of the solutions herein, further comprising: determining that a value of the operation parameter violates the constraint at a specific time point of the plurality of time point; and switching to a tracking-based control mode in which the context information is ignored and the control instruction is determined based on the reference information; adjusting the control instruction according to the tracking-based control mode; and operating the vehicle based on the adjusted control instruction such that the value of the operation parameter changes so as to satisfy the constraint or that a value of the operation parameter at a subsequent time point satisfies the constraint.
5. The method of any one or more of the solutions herein, wherein the operation parameter comprises a velocity or a position of the vehicle.
6. The method of any one or more of the solutions herein, wherein the control instruction relates to a wheel domain parameter that comprises at least one of a wheel speed, a wheel drive torque, a wheel brake torque, a road grade angle, a longitudinal torque-acceleration response model, or a fuel consumption estimation model.
7. The method of any one or more of the solutions herein, wherein the control instruction relates to an engine domain parameter that comprises at least one of an engine speed, an engine flywheel torque, a foundation air brake pressure, a gear position, a transmission efficiency gain set, a clutch engagement status, a gear ratio set, or a final drive ratio.
8. The method of any one or more of the solutions herein, wherein the constraint relates to a limit on a mechanical capacity of the vehicle.
9. The method of any one or more of the solutions herein, wherein a performance parameter of the vehicle when the vehicle traverses the path according to values of the operation parameter that are determined based on the tolerable ranges and the penalty information improves than when the vehicle traverses the path according to the reference information without the context information.
10. The method of any one or more of the solutions herein, wherein the performance parameter comprises at least one of fuel efficiency or acceleration jerkiness.
11. The method of any one or more of the solutions herein, wherein the vehicle is an autonomous vehicle that is operating in a Society of Automotive Engineers (SAE) Level 4 (L4) automation mode.
12. The method of any one or more of the solutions herein, wherein the plurality of time points correspond to a time horizon for which at least one of the reference information or the context information is available.
13. The method of any one or more of the solutions herein, wherein the time horizon is at least 5 seconds, or 6 seconds, or 8 seconds, or 10 seconds, or 12 seconds, or 15 seconds, or 16 seconds, or 18 seconds, or 20 seconds.
14. The method of any one or more of the solutions herein, wherein: the reference information further comprises a plurality of second reference values of a second operation parameter of the vehicle, each of the plurality of second reference values corresponding to one of the plurality of time points, the operation parameter and the second operation parameter collectively defining a state of the vehicle at each of the plurality of time points, the method further comprises determining a tolerable range of the second operation parameter for each of the plurality of time points based on the reference information and the context information, and the penalty information further comprises a plurality of second penalty weights each of which corresponds to a second modulation bandwidth indicating a difference between a tolerable range of the second operation parameter and a second constraint at one of the plurality of time points.
15. A system for controlling a vehicle, comprising: a mission planner configured to provide reference information and context information of the vehicle, the reference information relating to an operation parameter of the vehicle that describes mission waypoints of the vehicle at a plurality of time points during which the vehicle is to traverse a path, and the context information relating to a state of the vehicle during an operation of the vehicle at the plurality of time points or an environment enclosing the path; a dynamic model predictive control (MPC) controller coupled to the mission planner and configured to perform operations including: obtaining the reference information and the context information from the mission planner; determining a tolerable range of the operation parameter for each of the plurality of time points based on the reference information and the context information; obtaining penalty information including a plurality of penalty weights each of which corresponds to a modulation bandwidth indicating a difference between a tolerable range of the operation parameter and a constraint at one of the plurality of time points; determining a control instruction based on the tolerable ranges and the penalty information; and a vehicle control interface coupled to the MPC controller to obtain the control instruction and configured to cause the vehicle to operate based on the control instruction.
16. The system of any one or more of the solutions herein, further comprising a perception module configured to acquire environmental information of the environment, wherein: the vehicle is an autonomous vehicle operating in a Society of Automotive Engineers (SAE) Level 4 (L4) automation mode, and the plurality of time points correspond to a time horizon that relates to the perception module and the mission planning module.
17. The system of any one or more of the solutions herein, wherein the MPC controller comprises an uncertainty model trained to predict substantially in real time a tolerable range of the operation parameter at a specific time point based on at least one of a value of the operation parameter of the vehicle at a prior time point that precedes the specific time point, the reference information, or the context information.
18. The system of any one or more of the solutions herein, wherein the uncertainty model comprises a multivariate model trained based on balanced training data that represent multiple types of events relating to the operation of the vehicle or the path.
19. The system of any one or more of the solutions herein, wherein a performance parameter of the vehicle when the vehicle traverses the path according to values of the operation parameter that are determined based on the tolerable ranges and the penalty information improves than when the vehicle traverses the path according to reference values of the operation parameter that are determined based on the reference information without the context information.
20. An apparatus for controlling a vehicle, comprising a processor configured to perform steps including: obtaining reference information of an operation parameter of the vehicle, the operation parameter describing mission waypoints of the vehicle at a plurality of time points during which the vehicle is to traverse a path, the reference information including a plurality of reference values of the operation parameter, each of the plurality of reference values corresponding to one of the plurality of time points; obtaining context information of the vehicle that relates to a state of the vehicle during an operation of the vehicle at the plurality of time points and an environment enclosing the path; determining a tolerable range of the operation parameter for each of the plurality of time points based on the reference information and the context information; obtaining penalty information including a plurality of penalty weights each of which corresponds to a modulation bandwidth indicating a difference between a tolerable range of the operation parameter and a constraint at one of the plurality of time points; determining a control instruction based on the tolerable ranges and the penalty information; and operating the vehicle based on the control instruction such that a value of the operation parameter of the vehicle at each of at least one of the plurality of time points falls within a tolerable range at the time point.
21. One or more non-transitory computer readable program storage media having code stored thereon, the code, when executed by at least one processor, causing the at least one processor to implement one or more solutions herein.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for controlling a vehicle, comprising:
obtaining reference information relating to an operation parameter of the vehicle, the operation parameter describing mission waypoints of the vehicle at a plurality of time points during which the vehicle is to traverse a path, the reference information including a plurality of reference values of the operation parameter of the vehicle, each of the plurality of reference values corresponding to one of the plurality of time points;
obtaining context information of the vehicle that relates to a state of the vehicle during an operation of the vehicle at the plurality of time points or an environment enclosing the path;
determining a tolerable range of the operation parameter for each of the plurality of time points based on the reference information and the context information;
obtaining penalty information including a plurality of penalty weights each of which corresponds to a modulation bandwidth indicating a difference between a tolerable range and a constraint at one of the plurality of time points;
determining a control instruction based on the tolerable ranges and the penalty information; and
operating the vehicle based on the control instruction such that a value of the operation parameter of the vehicle at each of at least one of the plurality of time points falls within or close to a tolerable range at the time point so as to satisfy the constraint.

2. The method of claim 1, wherein:
the reference information comprises a value of the operation parameter at a prior time point that precedes the plurality of time points,
the context information comprises at least one of a mechanical capacity of the vehicle or environmental information of the environment enclosing the path, and
determining a tolerable range of the operation parameter for each of the plurality of time points based on the reference information and the context information comprises:
inputting the reference information and the context information into an
uncertainty model, the uncertainty model comprising a machine learning model trained to predict substantially in real time a tolerable range of the operation parameter at a specific time point based on at least one of a value of the operation parameter at a prior time point that precedes the specific time point, the mechanical capacity of the vehicle, or the environmental information.

3. The method of claim 1, further comprising:
determining that a value of the operation parameter violates the constraint at a specific time point of the plurality of time points;
adjusting the penalty information with respect to the specific time point or at least one time point following the specific time point;
adjusting the control instruction based on the adjusted penalty information; and
operating the vehicle based on the adjusted control instruction such that the value of the operation parameter of the vehicle changes so as to satisfy the constraint or that a value of the operation parameter at a subsequent time point satisfies the constraint.

4. The method of claim 1, further comprising:
determining that a value of the operation parameter violates the constraint at a specific time point of the plurality of time point; and
switching to a tracking-based control mode in which the context information is ignored and the control instruction is determined based on the reference information;
adjusting the control instruction according to the tracking-based control mode; and
operating the vehicle based on the adjusted control instruction such that the value of the operation parameter changes so as to satisfy the constraint or that a value of the operation parameter at a subsequent time point satisfies the constraint.

5. The method of claim 1, wherein the operation parameter comprises a velocity or a position of the vehicle.

6. The method of claim 1, wherein the control instruction relates to a wheel domain parameter that comprises at least one of a wheel speed, a wheel drive torque, a wheel brake torque, a road grade angle, a longitudinal torque-acceleration response model, or a fuel consumption estimation model.

7. The method of claim 1, wherein the control instruction relates to an engine domain parameter that comprises at least one of an engine speed, an engine flywheel torque, a foundation air brake pressure, a gear position, a transmission efficiency gain set, a clutch engagement status, a gear ratio set, or a final drive ratio.

8. The method of claim 1, wherein the constraint relates to a limit on a mechanical capacity of the vehicle.

9. The method of claim 1, wherein a performance parameter of the vehicle when the vehicle traverses the path according to values of the operation parameter that are determined based on the tolerable ranges and the penalty information improves than when the vehicle traverses the path according to the reference information without the context information.

10. The method of claim 9, wherein the performance parameter comprises at least one of fuel efficiency or acceleration jerkiness.

11. The method of claim 1, wherein the vehicle is an autonomous vehicle that is operating in a Society of Automotive Engineers (SAE) Level 4 (L4) automation mode.

12. The method of claim 1, wherein the plurality of time points correspond to a time horizon for which at least one of the reference information or the context information is available.

13. The method of claim 1, wherein the control instruction is configured to control at least one of longitudinal motion or lateral motion of the vehicle.

14. The method of claim 1, wherein:
the reference information further comprises a plurality of second reference values of a second operation parameter of the vehicle, each of the plurality of second reference values corresponding to one of the plurality of time points, the operation parameter and the second operation parameter collectively defining a state of the vehicle at each of the plurality of time points,
the method further comprises determining a tolerable range of the second operation parameter for each of the plurality of time points based on the reference information and the context information, and
the penalty information further comprises a plurality of second penalty weights each of which corresponds to a second modulation bandwidth indicating a difference between a tolerable range of the second operation parameter and a second constraint at one of the plurality of time points.

15. A system for controlling a vehicle, comprising:
a mission planner configured to provide reference information and context information of the vehicle, the reference information relating to an operation parameter of the vehicle that describes mission waypoints of the vehicle at a plurality of time points during which the vehicle is to traverse a path and context information, and the context information relating to a state of the vehicle during an operation of the vehicle at the plurality of time points or an environment enclosing the path;
a model predictive control (MPC) controller coupled to the mission planner and configured to perform operations including:
obtaining the reference information and the context information from the mission planner;
determining a tolerable range of the operation parameter for each of the plurality of time points based on the reference information and the context information;
obtaining penalty information including a plurality of penalty weights each of which corresponds to a modulation bandwidth indicating a difference between a tolerable range of the operation parameter and a constraint at one of the plurality of time points; and
determining a control instruction based on the tolerable ranges and the penalty information; and
a vehicle control interface coupled to the MPC controller to obtain the control instruction and configured to cause the vehicle to operate based on the control instruction.

16. The system of claim 15, further comprising a perception module configured to acquire environmental information of the environment, wherein:
the vehicle is an autonomous vehicle operating in a Society of Automotive Engineers (SAE) Level 4 (L4) automation mode, and
the plurality of time points correspond to a time horizon that relates to operations of the perception module and the mission planner.

17. The system of claim 15, wherein the MPC controller comprises an uncertainty model trained to predict substantially in real time a tolerable range of the operation parameter at a specific time point based on at least one of a value of the operation parameter of the vehicle at a prior time point that precedes the specific time point, the reference information, or the context information.

18. The system of claim 17, wherein the uncertainty model comprises a multivariate model trained based on balanced training data that represent multiple types of events relating to the operation of the vehicle or the path.

19. The system of claim 15, wherein a performance parameter of the vehicle when the vehicle traverses the path according to values of the operation parameter that are determined based on the tolerable ranges and the penalty information improves than when the vehicle traverses the path according to reference values of the operation parameter that are determined based on the reference information without the context information.

20. An apparatus for controlling a vehicle, comprising a processor configured to perform steps including:
obtaining reference information of an operation parameter of the vehicle, the reference information including a plurality of reference values of the operation parameter, the operation parameter describing mission waypoints of the vehicle at a plurality of time points during which the vehicle is to traverse a path, each of the plurality of reference values corresponding to one of the plurality of time points;
obtaining context information of the vehicle that relates to a state of the vehicle during an operation of the vehicle at the plurality of time points or an environment enclosing the path;
determining a tolerable range of the operation parameter for each of the plurality of time points based on the reference information and the context information;
obtaining penalty information including a plurality of penalty weights each of which corresponds to a modulation bandwidth indicating a difference between a tolerable range of the operation parameter and a constraint at one of the plurality of time points;
determining a control instruction based on the tolerable ranges and the penalty information; and
operating the vehicle based on the control instruction such that a value of the operation parameter of the vehicle at each of at least one of the plurality of time points falls within or close to a tolerable range at the time point so as to satisfy the constraint.
